(19) United States
(12) Patent Application Publication
(10) Pub. No.: US 2010/0091015 A1
(43) Pub. Date: Apr. 15, 2010

(54) Product, service, and market integration of three dimensional modeling/rendering software for the construction, remodeling, manufacturing, designing, buying, and/or selling of homes, businesses, structures, vehicles, and/or buildings

(76) Inventor: Robert Eric Heidel, Oak Ridge, TN (US)

Correspondence Address: Robert Eric Heidel, 896 West Outer Drive, Oak Ridge, TN, 37830, US

(21) Appl. No.: 12/587,144

(22) Filed: Oct. 2, 2009

Related U.S. Application Data
(60) Provisional application No. 61/196,103, filed on Oct. 15, 2008.

(51) Int. Cl. G06F 15/16; G06T 15/00

(52) U.S. Cl. 345/419; 709/219

(57) ABSTRACT

This specification encompasses a number of processes geared towards the integration of products, services, and markets into 3D modeling/rendering software platforms. Users of 3D modeling/rendering software platforms will be able to implement over one thousand various products and services into 3D models/renderings of homes, businesses, vehicles, structures, and/or buildings. Users will also be able to send created and/or manipulated 3D models/renderings to a virtual marketplace where commercial entities specializing in construction, remodeling, manufacturing, designing, buying, and/or selling markets will compete for business opportunities related to 3D models/renderings of homes, businesses, vehicles, structures, and/or buildings.

### CROSS-REFERENCE TO RELATED APPLICATION

U.S. Provisional Application No. 61/196,103, Product, Service, and Marketing Integration of 3D Modeling/Rendering Software for the Construction, Remodeling, Manufacturing, Designing, Buying, and/or Selling of Homes, Businesses, Structures, Vehicles, and/or Buildings

### FEDERALLY SPONSORED RESEARCH

None

### SEQUENCE LISTING

None

### BACKGROUND OF THE INVENTION

1. Field of Invention

This patent application pertains to an embodiment of a process for integrating products, services, and markets into 3D modeling/rendering software platforms for the construction, remodeling, manufacturing, designing, buying, and/or selling of homes, businesses, structures, vehicles, and/or buildings.

2. Discussion of Prior Art

There are many different forms of 3D modeling/rendering software that exist today and many different industries use 3D modeling/rendering software for various purposes. Various forms of 3D modeling/rendering software platforms are used in the motion picture, video game, medical, engineering, science, lighting, and architecture industries. In regards to architecture, companies such as Autodessys, Inc., Autodesk, DIALux, and many others have created software platforms that create 3D models/renderings of various architectural, lighting, and landscaping designs. The creation of 3D models/renderings within these software platforms is facilitated by the applications within the software and by the informed and experienced user of the software platform interfacing with the applications of the software platform. Users of the 3D modeling/rendering software platforms utilize the applications of the software platform to manipulate and design all aspects of a model/rendering. This patent application takes existing 3D modeling/rendering software platforms one step further by integrating existing and yet to be discovered products, services, and markets into the functionality, utility, applications, and overall design of 3D modeling/rendering software platforms.

3. Objects and Advantages

Accordingly, the integration of products, services, and markets into existing and yet to be discovered 3D modeling/rendering software programs has many advantages over past processes, applications, and software platforms in that:

(a) Every existing and yet to be discovered product and/or service associated with the construction, remodeling, manufacturing, designing, buying, and/or selling of homes, businesses, structures, vehicles, and/or buildings can be digitally implemented, rendered, manipulated, and integrated into a 3D model/rendering.
(b) Several thousand different products and services can be implemented into a 3D model/rendering software program which will allow a consumer to have a new level of personal freedom and choice when implementing products and services into a home, business, structure, vehicle, and/or building as well as in overall design of a home, business, structure, vehicle, and/or building.
(c) Market driven forces are added to 3D modeling/rendering software programs so that entities can compete for the facilitation of construction, remodeling, manufacturing, designing, buying, and/or selling of homes, businesses, structures, vehicles, and/or buildings.
(d) The virtual marketplace will create new markets and opportunities for consumers and commercial entities.
(e) The integration of products, services, and markets into 3D modeling/rendering software platforms will the utility of such software platforms more accessible, relevant, and realistic to the needs of consumers and commercial entities.
(f) The integration of markets into 3D modeling/rendering software platforms will allow for competition between commercial entities which will in turn drive prices of products and services down.
(g) The integration of markets into 3D modeling/rendering software platforms will allow for competition between commercial entities which will in turn drive the costs associated with the construction, remodeling, manufacturing, designing, buying, and/or selling of homes, businesses, structures, vehicles, and/or buildings down.
(h) The integration of products, services, and markets into 3D modeling/rendering software platforms will mean that software companies and commercial entities will create new jobs for individuals in information technology, computer software, construction, remodeling, manufacturing, designing, buying, and/or selling sectors of the economy.

### SUMMARY

The process allows for entities associated with the buying and/or selling of products and services within construction, remodeling, manufacturing, designing, buying, and/or selling markets to upload their products and services into an existing or yet to be discovered 3D modeling/rendering software platform so that users, individuals, and/or entities of said software platform can implement the uploaded products and services into a home, business, structure, vehicle, and/or building they are creating and/or manipulating using applications within said 3D modeling/rendering software platform.

The process allows for existing or yet to be discovered entities associated with the construction, remodeling, manufacturing, designing, buying, and/or selling of homes, businesses, structures, vehicles, and/or buildings to be able to can give estimates for, make bids for, advertise and offer their products and services for, create contracts for, accept credit and/or monetary transactions for, target geographical areas and consumer demographics for, and/or seek out business opportunities for the construction, remodeling, manufacturing, designing, buying, and/or selling of a home, business, structure, vehicle, and/or building that is created within a 3D modeling/rendering software platform. Commercial entities will compete for the facilitation of various products by being part of a virtual marketplace where 3D models/renderings of homes, businesses, structures, vehicles, and/or buildings will be sent after being created and/or manipulated within a 3D modeling/rendering software platform.

The process would allow for a user, individual, and/or entity of a 3D modeling/rendering software platform to implement various existing or yet to be discovered products and services into the a 3D model/rendering of a home, business, structure, vehicle, and/or building and allow for entities within the virtual marketplace to compete for business opportunities for the construction, remodeling, manufacturing, designing, buying, and/or selling of the home, business, structure, vehicle, and/or building.

This process integrates market-driven forces into the high-tech field of 3D computer modeling/rendering allows for users and/or individuals or entities of 3D modeling/rendering software platforms vested in the construction, remodeling, manufacturing, designing, buying, and/or selling of homes, businesses, structures, vehicles, and/or buildings to have an increased level of freedom and choice in facilitating and/or creating the physical dimensions, spatial dispositions, and/or design specifications of a home, business, structure, vehicle, and/or building when using a 3D modeling/rendering software platform.

### BRIEF DESCRIPTION OF DRAWINGS

FIG. 1A. This figure is a flowchart of an embodiment of an example of a 3D modeling/rendering software platform where various entities will upload products and services to the software program so that users and/or individuals or entities utilizing the software platform will be able to implement said products and services into a 3D model/rendering that is being created and/or manipulated. The various entities are associated with the buying and/or selling of products and services within markets associated with the construction, remodeling, and/or manufacturing of homes, businesses, structures, vehicles, and/or buildings.

FIG. 1B. This figure is a flowchart of an embodiment of an example of a 3D modeling/rendering software platform where various entities will upload products and services to the software program so that users and/or individuals or entities utilizing the software platform will be able to implement said products and services into a 3D model/rendering that is being created and/or manipulated. The various entities are associated with the buying and/or selling of products and services within markets associated with the designing, buying, and/or selling of homes, businesses, structures, vehicles, and/or buildings.

FIG. 2. This figure is a flowchart of an embodiment of an example of a user and/or individual or entity implementing the products and services into a 3D model/rendering of a home, business, structure, vehicle, and/or building that is being created and/or manipulated using an existing or yet to be discovered 3D modeling/rendering software platform.

FIG. 3. This figure is a flowchart of an embodiment of an example of a user and/or individual or entity uploading existing or yet to be discovered construction, architectural, remodeling, manufacturing, and/or engineering schematics and/or plans of a home, business, structure, vehicle, or building into a 3D modeling/rendering software platform whereby the user and/or individual or entity can implement products and services into the 3D model/rendering of a home, business, structure, vehicle, and/or building at their own volition.

FIG. 4A. This figure is a flowchart of an embodiment of an example of an entity associated with the construction, remodeling, and/or manufacturing of homes, businesses, structures, vehicles, and/or buildings having the ability to be able to give estimates for, make bids for, advertise and offer their products and services for, create contracts for, accept credit and/or monetary transactions for, target geographical areas and consumer demographics for, and/or seek out business opportunities for the construction, remodeling, and/or manufacturing of a home, business, structure, vehicle, and/or building that is created and/or manipulated as a 3D model/rendering using a 3D modeling/rendering software platform.

FIG. 4B. This figure is a flowchart of an embodiment of an example of an entity associated with the designing, buying, and/or selling of homes, businesses, structures, vehicles, and/or buildings having the ability to be able to give estimates for, make bids for, advertise and offer their products and services for, create contracts for, accept credit and/or monetary transactions for, target geographical areas and consumer demographics for, and/or seek out business opportunities for the designing, buying, and/or selling of a home, business, structure, vehicle, and/or building that is created and/or manipulated as a 3D model/rendering using a 3D modeling/rendering software platform.

FIG. 4C. This figure is a flowchart of an embodiment of an example that shows how a user and/or individual or entity interfaces with a 3D modeling/rendering software platform to create and/or manipulate a 3D model/rendering of a home, business, structure, vehicle, and/or building while implementing uploaded products and services into the 3D model/rendering. Applications within the 3D modeling/rendering software platform will then send the model/rendering to a virtual marketplace where entities can give estimates for, make bids for, advertise and offer their products and services for, create contracts for, accept credit and/or monetary transactions for, target geographical areas and consumer demographics for, and/or seek out business opportunities for the construction, remodeling, and/or manufacturing of homes, businesses, structures, vehicles, and/or buildings that are created and/or manipulated as a 3D model/rendering.

FIG. 4D. This figure is a flowchart of an embodiment of an example that shows how a user and/or individual or entity interfaces with a 3D modeling/rendering software platform to create and/or manipulate a 3D model/rendering of a home, business, structure, vehicle, and/or building while implementing uploaded products and services into the 3D model/rendering. Applications within the 3D modeling/rendering software platform will then send the model/rendering to a virtual marketplace where entities can give estimates for, make bids for, advertise and offer their products and services for, create contracts for, accept credit and/or monetary transactions for, target geographical areas and consumer demographics for, and/or seek out business opportunities for the designing, buying, and/or selling of homes, businesses, structures, vehicles, and/or buildings that are created and/or manipulated as a 3D model/rendering.

FIG. 5A. This figure is a flowchart of an embodiment of an example of how entities who upload their various products and services via direct, secure, and electronic linkages into a 3D modeling/rendering software platform will include the specifications, prices, warranties, brand, make, model, height, width, length, physical/spatial dimensions and dispositions, energy efficiency, weight, color, installation, design, utilizations, amenities, characteristics, applications, sizes, parts, pieces, labor, and/or any other relevant and particular specifications so that the user and/or individual or entity implementing the products and services into the 3D model/rendering will be able to see how the products and services will actually look within the physical/spatial dimensions and dispositions of a 3D model/rendering.

FIG. 5B. This figure is a flowchart of an embodiment of an example of entities creating 3D models/renderings of their products and services and uploading them to a 3D modeling/rendering software platform.

FIG. 6A. This figure is a flowchart of an embodiment of an example of how secure, direct, and electronic linkages will be created between a 3D modeling/rendering software platform and entities associated with buying and/or selling products or services within markets associated with the construction, remodeling, manufacturing, designing, buying, and/or selling of homes, businesses, structures, vehicles, and/or buildings.

FIG. 6B. This figure is a flowchart of an embodiment of an example of how secure, direct, and electronic linkages will be created between a 3D modeling/rendering software platform, a virtual marketplace, and entities associated with the construction, remodeling, manufacturing, designing, buying, and/or selling of homes, businesses, structures, vehicles, and/or buildings.

FIG. 7A. This figure is a flowchart of an embodiment of an example of how entities associated with the buying and/or selling of products and services within the markets of construction, remodeling, manufacturing, designing, buying, and/or selling of homes, businesses, structures, vehicles, and/or buildings will pay the licensor (the inventor) and licensee (an entity associated with the 3D modeling/rendering software industry) to have their products or services made available within a 3D modeling/rendering software platform so that users and/or individuals or entities can implement them into 3D models/renderings of homes, businesses, structures, vehicles, and/or buildings within a 3D modeling/rendering software platform.

FIG. 7B. This figure is a flowchart of an embodiment of an example of how entities associated with the construction, remodeling, manufacturing, designing, buying, and/or selling of homes, businesses, structures, vehicles, and/or buildings will pay the licensor (the inventor) and licensee (an entity associated with the 3D modeling/rendering software industry) to have the potential to give estimates for, make bids for, advertise and offer their products and services for, create contracts for, accept credit and/or monetary transactions for, target geographical areas and consumer demographics for, and/or seek out business opportunities for the construction, remodeling, manufacturing, designing, buying, and/or selling of a home, business, structure, vehicle, and/or building that is created and/or manipulated within a 3D modeling/rendering software platform and is afterwards sent to a virtual marketplace.

### DRAWINGS

### LIST OF REFERENCE NUMERALS

101—Construction Entities (uploading of products and services)
102—Remodeling Entities (uploading of products and services)
103—Manufacturing Entities (uploading of products and services)
104—Designing Entities (uploading of products and services)
105—Buying Entities (uploading of products and services)
106—Selling Entities (uploading of products and services)
107—Upload
108—Products and Services
109—3D Modeling/Rendering Software Platform
110—Direct, Secure, and Electronic Linkage
111—User and/or Individual or Entity
112—Implement
113—3D Model/Rendering of a Home, Business, Structure, Vehicle, and/or Building
201—Interface
202—Create and/or Manipulate (a 3D model/rendering)
301—Construction, Architectural, Remodeling, Manufacturing, and/or Engineering Schematics and/or Plans
302—Conversion (of schematics and/or plans)
401—Construction Entities (part of virtual marketplace)
402—Remodeling Entities (part of virtual marketplace)
403—Manufacturing Entities (part of virtual marketplace)
404—Designing Entities (part of virtual marketplace)
405—Buying Entities (part of virtual marketplace)
406—Selling Entities (part of virtual marketplace)
407—Give Estimates For (3D models/renderings)
408—Make Bids For (3D models/renderings)
409—Advertise and Offer Products and Services For (3D models/renderings)
410—Create Contracts For (3D models/renderings)
411—Accept Credit and/or Monetary Transactions For (3D models/renderings)
412—Target Geographical Areas and Consumer Demographics For (3D models/renderings)
413—Seek Out Business Opportunities For (3D models/renderings)
414—Virtual Marketplace
501—Specifications, Prices, Warranties, Brand, Make Model, Height, Width, Length, Physical/Spatial Dimensions and Dispositions, Energy Efficiency, Weight, Color, Installation, Design, Utilizations, Amenities, Characteristics, Applications, Sizes, Parts, Pieces, Labor, and/or any other Relevant and Particular Specifications (of products and services)
502—Create (3D models/renderings)
503—3D Models/Renderings of Products and Services (created by entities for uploading)
504—Applications (in a 3D modeling/rendering software that can convert 3D models/renderings created by entities into visualizations in a created and/or manipulated 3D environment)
505—Conversion (of 3D models/renderings of products and services into visualizations)
701—Pay
702—Licensor
703—Licensee
704—Sales and Advertising Revenue

### DETAILED DESCRIPTION

This patent application pertains to an embodiment for a process to integrate products, services, and markets into existing and yet to be discovered 3D modeling/rendering software platforms. This integration would allow for users and/or individuals or entities to create and/or manipulate 3D models/renderings of homes, businesses, structures, vehicles, and/or buildings while implementing existing or yet to be discovered products and services into said models/renderings. The process will also allow market forces to converge within 3D modeling/rendering software platform.

Entities associated with the buying and/or selling of products and services that can be implemented into a home, business, structure, vehicle, and/or building before, during, or after its construction, remodeling, manufacturing, designing, buying, and/or selling will upload 3D models/renderings of said products and services into a 3D modeling/rendering software platform. The uploading of products and services will be facilitated using direct, secure, and electronic linkages between 3D modeling/rendering software platforms and entities associated with the buying and selling of products and services as well as entities associated with the construction, remodeling, manufacturing, designing, buying, and/or selling of homes, businesses, structures, vehicles, and/or buildings. A user and/or individual or entity of a software platform will then implement the models/renderings of products and services into a 3D model/rendering that is being created and/or manipulated by interfacing with said 3D modeling/rendering software platform using a graphical interface.

The integration of products, services, and markets within 3D modeling/rendering software platforms is needed when a user and/or individual or entity is creating and/or manipulating a 3D model/rendering of a home, business, structure, vehicle, and/or building. If the user and/or individual or entity uses existing or yet to be discovered construction, architectural, remodeling, manufacturing, and/or engineering schematics and/or plans to guide the creation and/or manipulation of a 3D model/rendering of a home, business, structure, vehicle, and/or building within a 3D modeling/rendering software platform, then two possibilities can occur for the user and/or individual or entity to be able to implement products and services into the 3D model/rendering.

First, the 3D modeling/rendering software platform can either have applications that can convert the existing or yet to be discovered construction, architectural, remodeling, manufacturing, and/or engineering schematics and/or plans into a 3D model/rendering within the 3D modeling/rendering software platform after the schematics and/or plans have been uploaded into the software platform. Second, a user and/or individual or entity will have to create and/or manipulate a 3D model/rendering from scratch using existing or yet to be discovered construction, architectural, remodeling, manufacturing, and/or engineering schematics and/or plans by interfacing with a 3D modeling/rendering software platform. In either instance, once the schematics and/or plans have been converted by applications within the 3D modeling/rendering software platform or created and/or manipulated by a user and/or individual or entity interfacing with a 3D modeling/rendering software platform, the user and/or individual or entity will implement products or services that have been uploaded by various entities into a 3D model/rendering by interfacing with a 3D modeling/rendering software platform.

The terms, 3D modeling/rendering software platform, is used vaguely within the specification to denote any existing or yet to be discovered software program that has applications that allow for a user and/or individual or entity to create and/or manipulate a 3D model/rendering of a home, business, structure, vehicle, and/or building. The term “3D” within the specification denotes “three-dimensional.” A 3D model/rendering can be defined as a three-dimensional representation of geometric or mathematical data that is stored into a memory device or apparatus in a computer so that calculations and applications can be performed to create and/or manipulate a graphical model or rendering. These 3D model/renderings can be viewed in real-time as calculations, applications, implementations, manipulations, and alterations change the representation of geometric or mathematical data. A 3D model is a process whereby an object and/or piece of matter is formed or shaped according to geometric or mathematical data. A model can be created and/or manipulated by means of an existing or yet to be discovered procedure or simulation. In order for an object to be modeled or rendered, it must be placed within the confines of a scene or graphical representation. This layout of an object helps to define physical/spatial relationships, dimensions, and dispositions between other objects in a scene or graphical representation in regards to location, size, and placement. A rendering is basically a conversion of a model into an image or graphical representation by means of simulating light transport to create photorealistic images and graphical representations or in some instances non-photorealistic images and graphical representations. This conversion of a model to a rendering pertains to how much light exists within a scene or graphical representation and how surfaces of objects and/or matter within a scene or graphical representation interact with light.

The 3D modeling/rendering software platform will have applications that expedite the processes by which users and/or individuals or entities can integrate products, services, and markets pertinent to the construction, remodeling, manufacturing, designing, buying, and/or selling of homes, businesses, structures, vehicles, and/or buildings that are created and/or manipulated as 3D models/renderings. The user and/or individual or entity will purchase the rights to use the 3D modeling/rendering software platform and its applications. The user and/or individual or entity will then install and/or download the 3D modeling/rendering software platform and its applications to a computer or any existing or yet to be discovered electronic device that can facilitate the applications of the software program. The 3D modeling/rendering software platform can be written to a disk and/or downloaded and then installed into a computer's hard drive, memory, and/or RAM. The computer's operating system software would then interface with the computer's hardware to execute the applications of the 3D modeling/rendering software platform. The 3D modeling/rendering software platform can be written in any high-level programming language, machine language, and/or assembly language that exists or yet has been discovered and can be compiled, interpreted, and/or assembled into machine language object code by any means that exists or has yet been discovered. The 3D modeling/rendering software platform would be loaded into the computer's storage so that it can be executed.

The user and/or individual or entity will then interface with the 3D modeling/rendering software platform and its applications to facilitate the creation and/or manipulation of 3D models/renderings of homes, businesses, structure, vehicles, and/or buildings while implementing products and services and changing the physical/spatial dimensions and dispositions of the home, business, structure, vehicle, and/or building. This will be conducted by the user, individual, and/or entity interfacing with the 3D modeling/rendering software platform and its applications and inputting data via various graphical user interfaces to create and/or manipulate 3D models/renderings.

The instructions contained in the 3D modeling/rendering software platform and its applications would pass from the software itself, through the system software and operating software, to the computer hardware that receives the instruction as the aforementioned machine code. These instructions will make the computer facilitate the operations and applications that a 3D modeling/rendering software platform allows for user and/or individuals or entities to carry out. These instructions can be performed sequentially, conditionally, iteratively, and/or any other fashion depending upon the applications of the 3D modeling/rendering software platform that the user and/or individual entity is using.

The interconnection between networks (be it LAN, WAN, WLAN, and/or WWAN) of the user and/or individual or entity utilizing the 3D modeling/rendering software platform and the entities associated with the construction, remodeling, manufacturing, designing, buying, and/or selling of homes, businesses, structures, vehicles, and/or buildings will be facilitated by any means that exists or has yet been discovered for electronic business-to-business (B2B), business-to-consumer (B2C), and/or consumer-to-consumer (C2C) communications and transactions. The same will apply to entities that are associated with the buying and/or selling of products and services that can be implemented into a home, business, structure, vehicle, and/or building before, during, or after its construction, remodeling, manufacturing, designing, buying, and/or selling.

In instances where sensitive information is being exchanged within the applications and functions of the 3D modeling/rendering software platform or between respective servers of individuals, users, and/or entities, any existing or yet to be discovered form of secure transmission of data and information can be utilized to create the direct, secure, and electronic linkage between networks of the user and/or individual or entity and various businesses, organizations, entities, and/or institutions.

Every action and application associated with the uploading of products and services to a 3D modeling/rendering software platform will occur between the respective servers of the user and/or individual or entity of the software platform and the market entities wishing to upload products and services to the software platform. The same applies to entities wanting to be part of a virtual marketplace where said entities will have the ability to give estimates for, make bids for, advertise and offer their products and services for, create contracts for, accept credit and/or monetary transactions for, target geographical areas and consumer demographics for, and/or seek out business opportunities for the construction, remodeling, manufacturing, designing, buying, and/or selling of a home, business, structure, vehicle, and/or building that is created and/or manipulated within an existing or yet to be discovered 3D modeling/rendering software platform.

The creation of direct, secure, and electronic linkages between users and/or individuals or entities using the 3D modeling/rendering software platform and its applications with various organizations, businesses, institutions, and/or entities is facilitated so that 1) entities' products and services can be uploaded into the software platform and implemented into 3D models/renderings, 2) entities can compete for the facilitation of the construction, remodeling, manufacturing, designing, buying, and/or selling of homes, businesses, structures, vehicles, and/or buildings, and 3) created and/or manipulated 3D models/renderings of homes, businesses, structures, vehicles, and/or buildings can be sent to a virtual marketplace. The data sent via said linkages can be encrypted at any existing or yet to be discovered bit level to ensure secure transmission and protection of data exchanged between servers.

Entities that upload their various products and services into an existing or yet to be discovered 3D modeling/rendering software platform will include the specifications, prices, warranties, brand, make, model, height, width, length, physical/spatial dimensions and dispositions, energy efficiency, weight, color, installation, design, utilizations, amenities, characteristics, applications, sizes, parts, pieces, labor, and/or particular specifications that are relevant so that the user and/or individual or entity implementing the products and services into the 3D model/rendering will be able to see how the product or service will actually look within the physical/spatial dimensions and dispositions of the 3D model/rendering being created by a user and/or individual or entity interfacing with the 3D modeling/rendering software platform. The uploading of existing and/or yet to be discovered products and services will be facilitated by a secure, direct, and electronic linkage created by applications within a 3D modeling/rendering software platform.

Entities associated with the buying and/or selling of products and services within the markets of construction, remodeling, manufacturing, designing, buying, and/or selling of homes, businesses, structures, vehicles, and/or buildings will pay the licensor (the inventor) and licensee (an entity associated with the 3D modeling/rendering software industry) to have their products or services made available within a 3D modeling/rendering software platform.

Also, entities associated with the construction, remodeling, manufacturing, designing, buying, and/or selling of homes, businesses, structures, vehicles, and/or buildings will have the ability to give estimates for, make bids for, advertise and offer their products and services for, create contracts for, accept credit and/or monetary transactions for, target geographical areas and consumer demographics for, and/or seek out business opportunities for the construction, remodeling, manufacturing, designing, buying, and/or selling of a home, business, structure, vehicle, and/or building that is created and/or manipulated within an existing or yet to be discovered 3D modeling/rendering software platform. The ability to give estimates, make bids, advertise and offer products and services, create contracts, accept credit and/or monetary transactions, target geographical areas and consumer demographics, and/or seek out business opportunities is facilitated by a secure, direct, and electronic linkage between entities and an existing or yet to be discovered 3D modeling/rendering software platform.

Entities associated with the constructing, remodeling, manufacturing, designing, buying, and/or selling of homes, businesses, structures, vehicles, and/or buildings will pay the licensor (the inventor) and licensee (an entity associated with the 3D modeling/rendering software industry) to have the potential to give estimates for, make bids for, advertise and offer their products and services for, create contracts for, accept credit and/or monetary transactions for, target geographical areas and consumer demographics for, and/or seek out business opportunities for the construction, remodeling, manufacturing, designing, buying, and/or selling of a home, business, structure, vehicle, and/or building that is created and/or manipulated within a 3D modeling/rendering software platform.

The virtual marketplace created by a 3D modeling/rendering software platform is where market integration occurs between users and/or individuals or entities and market entities within the construction, remodeling, manufacturing, designing, buying, and/or selling sectors of an economy. The term, virtual marketplace, is used in a vague manner within this patent specification to denote any sort of existing or yet to be discovered electronic medium and/or domain where entities and consumers can exchange and upload data. The virtual marketplace will be created by applications in a 3D modeling/rendering software program whereby users and/or individuals or entities can electronically send created and/or manipulated 3D models/renderings of homes, businesses, structures, vehicles, and/or buildings that have had products and services and/or changes and/or additions to the physical/spatial dimensions and dispositions.

The secure, direct, and electronic linkages created by applications within a 3D modeling/rendering software platform allow for entities to upload products and services so that the products and services can be implemented into a 3D model/rendering of a home, business, structure, vehicle, and/or building. These linkages also serve the function of allowing entities associated with the construction, remodeling, manufacturing, designing, buying, and/or selling of homes, businesses, structures, vehicles, and/or buildings to give estimates for, make bids for, advertise and offer their products and services for, create contracts for, accept credit and/or monetary transactions for, target geographical areas and consumer demographics for, and/or seek out business opportunities for the construction, remodeling, manufacturing, designing, buying, and/or selling of a home, business, structure, vehicle, and/or building that is created and/or manipulated within a 3D modeling/rendering software platform.

The linkages also allow for these entities to have access to a virtual marketplace where users and/or individuals and entities will send newly created and/or manipulated 3D models/renderings as well as for 3D models/renderings to be electronically sent to their respective businesses before, during, or after their creation and/or manipulation. Direct, secure, and electronic linkages, for purposes of this patent application, can be defined as any existing or yet to be discovered electronic connection between the respective servers, networks, intra- and/or internet interfaces, web-based interfaces, websites, and/or any kind of electronic business-to-business (B2B), business-to-consumer (B2C), and/or consumer-to-consumer (C2C) communications system that exists or has yet been discovered.

The linkages are essential to the integration of products, services, and markets within 3D modeling/rendering software platforms because 1) they allow for direct, secure, and electronic transmission of data between user and/or individuals or entities creating and/or manipulating 3D models/renderings and entities who want to have their products and services made available in 3D modeling/rendering software platforms and 2) so that market entities can facilitate the actual construction, remodeling, manufacturing, designing, buying, and/or selling of homes, businesses, structures, vehicles, and/or buildings. These linkages will be created by a 3D modeling/rendering software platform using any kind of existing or yet to be discovered applications that can make electronic connections between respective electronic servers and networks of users, individuals, and/or commercial entities and transmit data in a secure fashion.

One example, but not meant to be a limitation of the scope of this patent application, would be for 3D models/renderings to be sent to a web-based marketplace created by and/or co-existing with a 3D modeling/rendering software program through direct, secure, and electronic linkages. The virtual marketplace can be created by applications within a 3D modeling/rendering software platform or a web-based virtual marketplace can be created and co-exist with the 3D modeling/rendering software program. In either instance, direct, secure, and electronic linkages will exist between the 3D modeling/rendering software program and various market entities so that the user and/or individuals or entities can send 3D models/renderings of homes, businesses, structures, vehicles, and/or buildings to a virtual marketplace where entities can compete for the facilitation of any changes and/or additions specified in the 3D model/rendering. The virtual marketplace will allow for entities that have paid the licensor and/or licensee of the patent for the opportunity to compete for the facilitation and/or implementation of products and services and/or changes and/or additions of a home, business, structure, vehicle, and/or building.

The website and/or virtual marketplace can be database-driven and can be written in an SQL style of programming language that is utilized for retrieving and managing data in relational database management system. Examples of database management systems include PostgreSQL, MySQL, DB2, and Oracle. Users of the web-based virtual marketplace interface will potentially need HTML interfaces, CGI form processing, JavaScript, and/or PHP to interact with the database through the web-based virtual marketplace interface on the front end. For application scripting purposes, Python, Ruby, Perl, and any other existing or yet to be discovered application could be utilized to complete processing tasks that connect the web-based virtual marketplace interface at the front end to the database at the back end.

In summation, market entities that buy and sell products and services associated with the construction, remodeling, manufacturing, designing, buying, and/or selling of homes, businesses, structures, vehicles, and/or buildings will create 3D model/renderings of their subsequent products and services. Market entities will pay the licensor and/or licensee of the patent for the ability to upload products and services into 3D modeling/rendering software platforms. These market entities will then upload the 3D models/renderings of their subsequent products and services to a 3D modeling/rendering software platform via a direct, secure, and electronic linkage between the software platform's server and/or network and the market entities' server and/or network. Users, individuals, and/or entities of 3D modeling/rendering software platform will then implement said modeled/rendered products and services into 3D models/renderings of homes, businesses, structures, vehicles, and/or buildings that are being created and/or manipulated within said software platform. Once the 3D model/rendering of the home, business, structure, vehicle, and/or building is completed, the user, individual, and/or entity will send the newly created and/or manipulated model/rendering to a virtual marketplace via a direct, secure, and electronic linkage. Market entities associated with the construction, remodeling, manufacturing, designing, buying, and/or selling of homes, businesses, structures, vehicles, and/or buildings will pay the licensor and/or licensee for the ability to give estimates for, make bids for, advertise and offer their products and services for, create contracts for, accept credit and/or monetary transactions for, target geographical areas and consumer demographics for, and/or seek out business opportunities for 3D model/renderings that have been sent to the virtual marketplace. Market entities will compete for the facilitation of constructing, remodeling, manufacturing, designing, buying, and/or selling of the created and/or manipulated 3D model/rendering within the virtual marketplace.

### Products and Services

Examples of products or services that can be uploaded into a 3D modeling/rendering software platform to be implemented into a 3D model/rendering of a home include but are not limited to refrigerators, clothes washers, clothes dryers, dishwashers, freezers, telephones, microwaves, stoves, ovens, stove tops, walk-in freezers, hot water heaters, garbage compactors, garbage cans, recycling compactors and cans, laundry chutes, food disposals, natural gas lines, appliances that utilize gas, televisions, stereos, stereo systems, audio systems, receivers, amplifiers, speakers, stereo wiring, home entertainment centers, home appliances, home theatres, humidors, wine cellars, kitchen sinks, kitchen faucets, kitchen counters, kitchen cabinets, beer and wine dispensers, water dispensers, kitchen sinks, doors, door frames, door knobs, door locks, door stops, door handles, door windows, sliding glass doors, dog doors, dog houses, cabinet knobs, bathroom sinks, toilets, showers, shower doors, bathtubs, vanities, bathroom cabinets, bathroom closets, toilet paper holders, toilet paper dispensers, hand dryers, shower heads, bathroom faucets, bath knobs, shower curtains, shower rods, beds, cribs, changing stations, bedroom suites, bathroom suites, living room suites, chest of drawers, pillows, bedding, duvets, bedside tables, dressers, closets, closet rods, closet shelves, storage spaces, shelves, fabrics, clocks, garages, garage doors, garage door openers, tool boxes, fans, lamps, lighting schemes, fluorescent lights, light switches, lighting fixtures, lights, chandeliers, electrical systems, electronic displays, electrical wiring, electrical outlets, wall outlets, circuit boxes, conduits, wind turbines, solar panels, generators, convertors, invertors, surge protectors, cable systems, cable wiring, Internet systems, Internet wiring, cable outlets, Internet outlets, telephone outlets, wireless routers, servers, computers, security systems, computer software and hardware, telephone systems, telephone wiring, plumbing systems, pipes, copper tubing, PVC pipe, sewer connections, utility connections, septic tanks, water systems, elevators, handicap accessible apparatuses, carpets, flooring, floor tiles, hardwood floors, fireplaces, ceilings, mirrors, counters, stairs, paintings, cabinets, painting frames, picture frames, tables, desks, dining tables, end tables, coffee tables, chairs, recliners, couches, stools, book shelves, seats, furniture, roofs, decks, shingles, stucco, brick, columns, guttering, siding, pools, landscaping, grass, dirt, cement, bushes, plants, trees, flowers, gardens, Jacuzzis, waterfalls, statues, water slides, pool supplies, walkways, cooking grills, outside and inside bars, gazebos, gravels, driveways, walkways, mailboxes, sprinkler systems, fences, gates, paths, irrigation systems, lake docks, boat docks, ocean docks, windows, window treatments, window screens, window frames, blinds, curtains, drapes, shades, window handles, window locks, window bars, glass, window insulation, window sills, insulation, foundations, walls, paint, crown mouldings, wall trims, wallpaper, railings, gratings, cinder blocks, concrete blocks, stones, foundations, paints, wallpaper, urinals, roofing, drywall, asphalt, concrete, brick, wood, timber, lumber, gutters, veneer, plastic laminate, wood paneling, panels, case goods, millwork, trims, sills, prefabricated materials, soil, beams, trusses, cladding, tiles, steel, columns, rebar, floor joints, walls, stairs, doors, door knobs, locking mechanisms, iron, aluminum, tin, titanium, chrome, gold, silver, ceramics, tiles, fixtures, ceilings, polymers, plastics, pipes, conduits, films, fibers, synthetic or semi-synthetic organic condensation or polymerization products, fabrics, synthetic foams, cement bonded composites, fiberglass, conveying systems, any existing or yet to be discovered composite construction and/or building materials, any existing or yet to be discovered plaster, any existing or yet to be discovered plastics, and/or another type of building material that exists or has yet been discovered, pots, pans, china, bowls, dishes, baking sheets, stove eyes, silverware, plates, utensils, towels, washcloths, linens, fire alarms, smoke detectors, carbon monoxide detectors, central heat and air systems, window air conditioner units, heaters, furnaces, and/or any other sort of product, service, material, labor, carpentry, or matter that exists or has yet been discovered associated with the construction, remodeling, manufacturing, designing, buying, and/or selling of a home.

Examples of products or services that can be uploaded into a 3D modeling/rendering software platform to be implemented into a 3D model/rendering of a business include but are not limited to cubicles, work stations, offices, desks, computers, furniture, computer software and hardware, security systems, windows, bathrooms, toilets, office suites, urinals, copiers, printers, fax machines, telephones, electrical systems, plumbing systems, water systems, wall outlets, cable outlets, internet servers, internet systems, chairs, seats, couches, tables, elevators, stairs, doors, cabinets, refrigerators, cabinets, walls, paint, wallpaper, sinks, coffee machines, vending machines, kitchens, counters, sinks, railings, gratings, cinder blocks, concrete blocks, stones, foundations, paints, wallpaper, urinals, roofing, drywall, asphalt, concrete, brick, wood, timber, lumber, gutters, veneer, plastic laminate, wood paneling, panels, case goods, millwork, trims, sills, sprinkler systems, prefabricated materials, soil, beams, trusses, cladding, tiles, steel, columns, rebar, floor joints, walls, stairs, doors, door knobs, locking mechanisms, iron, aluminum, tin, titanium, chrome, gold, silver, ceramics, tiles, fixtures, ceilings, polymers, plastics, pipes, conduits, films, fibers, synthetic or semi-synthetic organic condensation or polymerization products, fabrics, synthetic foams, cement bonded composites, fiberglass, conveying systems, any existing or yet to be discovered composite construction and/or building materials, any existing or yet to be discovered plaster, any existing or yet to be discovered plastics, and/or another type of building material that exists or has yet been discovered and/or any other sort of product or service that exists or has yet been discovered that may be utilized in a business. Due to the plethora of different existing and yet to be discovered businesses and the particular products, services, and/or markets they are associated with, it would be redundant and time-consuming to list all of the possibilities. A better approach is to list businesses that can be designed using a 3D modeling/rendering software platform and one can ascertain the different kinds of products and services that could be potentially implemented into the business. Types of businesses include but are not limited to retailers, wholesalers, distributors, franchisors, franchisees, sole proprietorships, limited liability corporations, corporations, general partnerships, limited partnerships, limited liability partnerships, consumer cooperatives, worker cooperatives, manufacturers, service businesses, agricultural and mining businesses, information technology businesses, financial and capital businesses, utility businesses, real estate businesses, service organizations, procurement organizations, communications and telecommunications businesses, transportation businesses, and/or any other sort of commercial private or public business entity that exists or has yet been discovered. Once the 3D model/rendering of the business is created and/or manipulated within a 3D modeling/rendering software platform, a user of a 3D modeling/rendering software platform can implement products and services that are relevant and needed within said type of business or entity.

Examples of products or services that can be uploaded into a 3D modeling/rendering software platform to be implemented into a 3D model/rendering of a vehicle include but are not limited to doors, seats, seat belts, steering wheels, foot pedals, air conditioning systems, engines, power trains, clutches, front and rear suspensions, shock absorbers, struts, springs, motor mounts, tie rods, ball joints, control arms, torsion bars, strut rods, spindles, fuel injectors, fuel injector systems, drive trains, tires, rims, air cleaners and filters, coolant reservoirs, power steering reservoirs, brake fluid reservoirs, reservoir caps, dipsticks, transmissions, timing belts, superchargers, intercoolers, exhausts, exhaust systems, exhaust pipes, emission control systems, oxygen sensors, batteries, alternators, distributors, cylinders, catalytic convertors, carburetors, spark plugs, intake and exhaust valves, pistons, piston rings, connecting rods, crankshafts, sumps, rocker arms and springs, valve covers, intake ports, oil pans, camshafts, rod bearings, gear boxes, pistons, connecting rods, axles, blocks, heads, gaskets, calipers, brake rotors, mufflers, radiators, exhaust manifolds, master cylinders, cylinders, cylinder head gaskets, valve lifters, overhead cams, combination valves, torque convertors, ignition systems, ignition wires, spark plug wires, distributor caps, rotors, high voltage coil leads, ignition signal sensors, ignition modules, ignition coils, hoses, transmission cooling lines, water pumps, fans, thermostats, electric starter motors, starter solenoids, computers, odometers, electronic displays, seat covers, cargo liners, floor mats, floor liners, carpets, wood finishing, leather, upholstery, vinyl, cloth, dashboards, dash covers, dash trims, organizers, headliners, sun visors, rocker panels, buttons, electrical wiring, audio systems, speakers, amplifiers, radios, CD players and changers, mp3 docks and devices, tweeters, gauges, DVD players, Blu-ray players, video game platforms, TV screens, cell phone docks, GPS systems, scanners, digital displays, back-up cameras, windows, power windows, window visors, pillar posts, fender trims, armrests, consoles, glove compartments, power door locks, windshields, sunroofs, rearview mirrors, side mirrors, bug deflectors, gear shifters, brake lights, tag lights, head lights, fog lamps, turn signals, windshield wipers, front and rear splashes, door sill guards, wheel arches, hoods, fenders, roofs, panels, bumpers, spoilers, and/or any other sort of product, service, material, labor, carpentry, or matter that exists or has yet been discovered associated with the construction, remodeling, manufacturing, designing, buying, and/or selling of a vehicle. The term vehicle is used vaguely to describe any sort of moving transportation apparatus of humans and/or matter from one destination to another. Examples of vehicles that products and services could be implemented into using an existing or yet to be discovered 3D modeling/rendering software platform could be but are not limited to cars, trucks, tow trucks, SUVs, buses, coaches, construction equipment, tractors, trains, trams, planes, boats, ships, yachts, vans, ATVs, motorcycles, racing vehicles, tractor trailers, spacecraft, elevators, escalators, barges, commercial ships, cruise ships, river boats, scooters, automobiles, submarines, submersibles, amphibious vehicles, amphibious ATVs, hovercrafts, aircraft, ambulances, utility vehicles, delivery vehicles, snowmobiles, fire engines, subway trains and cars, rail cars, train engines, locomotives, tanks, APCs, helicopters, unmanned aircraft, forklifts, limousines, tanks, assault vehicles, and/or any sort of non-living means of transporting humans and/or matter that exists or has yet been discovered. Different kinds of vehicles will require varying kinds of products and services according to their utility. A user and/or individual or entity creating and/or manipulating a 3D model/rendering of a vehicle using a 3D modeling/rendering software platform will implement products and services relevant to the kind of vehicle they are creating and/or manipulating within said 3D modeling/rendering software platform.

Examples of products and services that could be uploaded into a 3D modeling/rendering software platform and implemented into a 3D model/rendering of a building that is being created within a 3D modeling/software platform include but are not limited to the kind of construction materials needed to construct a building such as insulation, cement, metals, mortar, electrical systems, electrical wiring, copper wiring, air conditioning systems, pipes, wires, HVAC systems, telephone systems, computer servers, telecommunication systems, natural gas lines, computer networks, furniture, security systems, flooring, lighting systems, elevators, carpeting, windows, generators, plumbing systems, sinks, vanities, toilets, toilet stalls, hand dryers, paper towel dispensers, kitchens, storage units, counters, cabinets, cubicles, desks, chairs, tables, TVs, elevators, stairways, fire suppression systems, railings, gratings, cinder blocks, concrete blocks, stones, foundations, paints, wallpaper, urinals, roofing, drywall, asphalt, concrete, brick, wood, timber, lumber, gutters, veneer, plastic laminate, wood paneling, panels, case goods, millwork, trims, sills, sprinkler systems, prefabricated materials, soil, beams, trusses, cladding, tiles, steel, columns, rebar, floor joints, walls, stairs, doors, door knobs, locking mechanisms, iron, aluminum, tin, titanium, chrome, gold, silver, ceramics, tiles, fixtures, ceilings, polymers, plastics, pipes, conduits, films, fibers, synthetic or semi-synthetic organic condensation or polymerization products, fabrics, synthetic foams, cement bonded composites, fiberglass, conveying systems, any existing or yet to be discovered composite construction and/or building materials, any existing or yet to be discovered plaster, any existing or yet to be discovered plastics, and/or another type of building material that exists or has yet been discovered. Different kinds of buildings will require varying kinds of products and services according to their utility, design, and physical and spatial dimensions and dispositions. A user and/or individual or entity creating and/or manipulating a 3D model/rendering of a building using a 3D modeling/rendering software platform will implement products and services relevant to the kind of building they are creating and/or manipulating within said 3D modeling/rendering software platform.

Structures, for reasons of this specification, can include any number of existing or yet to be discovered structures such as but not limited to towers, dams, bridges, roads, overpasses, train trusses, train tunnels, car tunnels, canals, domes, art, homes, businesses, malls, buildings, vehicles, airports, arches, cathedrals, stadiums, arenas, concert halls, theatres, pedestrian malls, paths, auditoriums, museums, churches, indoor waterfalls, barns, gas stations, platforms, docks, space stations, train stations, aqueducts, cranes, satellites, satellite dishes, hangers, smoke stacks, on-shore and off-shore refineries, factories, radio telescopes, skyscrapers, causeways, parking structures, amphitheatres, castles, levees, windmills, retractable structures, and/or any other sort of structure that exists or has yet been discovered. Examples of products and services that can be uploaded into a 3D modeling/rendering software platform and implemented into a 3D model/rendering of a structure that is being created within a 3D modeling/software platform include but are not limited to metals, railings, gratings, cinder blocks, concrete blocks, stones, foundations, paints, wallpaper, urinals, roofing, drywall, asphalt, concrete, brick, wood, timber, lumber, gutters, veneer, plastic laminate, wood paneling, panels, case goods, millwork, trims, sills, sprinkler systems, prefabricated materials, soil, beams, trusses, cladding, tiles, steel, columns, rebar, floor joints, walls, stairs, doors, door knobs, locking mechanisms, iron, aluminum, tin, titanium, chrome, gold, silver, ceramics, tiles, fixtures, ceilings, polymers, plastics, pipes, conduits, films, fibers, synthetic or semi-synthetic organic condensation or polymerization products, fabrics, synthetic foams, cement bonded composites, fiberglass, conveying systems, any existing or yet to be discovered composite construction and/or building materials, any existing or yet to be discovered plaster, any existing or yet to be discovered plastics, and/or another type of building material that exists or has yet been discovered. Different kinds of structures will require varying kinds of products and services according to their utility, design, and physical and spatial dimensions and dispositions. A user and/or individual or entity creating and/or manipulating a 3D model/rendering of a structure using a 3D modeling/rendering software platform will implement products and services relevant to the kind of structure they are creating and/or manipulating within said 3D modeling/rendering software platform.

### EXAMPLES

An example of how the integration of products, services, and markets into 3D modeling/rendering software platforms follows that is not meant to be a limitation of the specification. A real estate developer who is planning a new subdivision or commercial development with varying types of homes, businesses, structures, vehicles, and/or buildings within it will upload existing or yet to be discovered construction, architectural, remodeling, manufacturing, and/or engineering schematics and/or plans of the homes, businesses, structures, vehicles, and/or buildings into a 3D modeling/rendering software platform or have the homes, businesses, structures, vehicles, and/or buildings created and/or manipulated from scratch by a user and/or individual or entity interfacing with a 3D modeling/rendering software platform. The real estate developer would then invite potential investors, entities, and/or buyers of the homes, businesses, structures, vehicles, and/or buildings to pick and choose the products and services to be implemented into a home, business, structure, vehicle, and/or building and the physical/spatial dimensions and dispositions of the home, business, structure, vehicle, and/or building. A user and/or individual or entity would then create and/or manipulate 3D models/renderings of the homes, businesses, structures, vehicles, and/or buildings with the particular design specifications and physical/spatial dimensions and dispositions that the investors, entities, and/or buyers specify. The investors, entities, and/or buyers also have the ability to pick and choose what products and services they wish to be implemented into the 3D model/rendering and the user and/or individual or entity would implement the products and services accordingly. The real estate developer could then send the newly created and/or manipulated 3D models/renderings to a virtual marketplace created by the 3D modeling/rendering software platform where entities associated with the construction, remodeling, manufacturing, designing, buying, and/or selling of homes, businesses, structures, vehicles, and/or buildings can give estimates for, make bids for, advertise and offer their products and services for, create contracts for, accept credit and/or monetary transactions for, target geographical areas and consumer demographics for, and/or seek out business opportunities for the construction, remodeling, manufacturing, designing, buying, and/or selling of a home, business, structure, vehicle, and/or building that is created and/or manipulated within a 3D modeling/rendering software platform. Any entity who has paid the licensor and licensee for the ability to give estimates, make bids, advertise and offer their products and services, create contracts, accept credit and/or monetary transactions, target geographical areas and consumer demographics, and/or seek out opportunities pertaining to 3D models/renderings created and/or manipulated within a 3D modeling/rendering software platform will then have the opportunity to compete for the construction, remodeling, manufacturing, designing, buying, and/or selling of the homes, businesses, structures, vehicles, and/or buildings. Any entity who has paid the licensor and licensee for the ability to upload their subsequent products and services into a 3D modeling/rendering software platform will have the opportunity to sell their products and services to consumers who are using a 3D modeling/rendering software platform to create and/or manipulate a 3D model/rendering of a home, business, structure, vehicle, and/or building. This is where market, product, and service integration into 3D modeling/rendering software platforms takes place. The process allows for entities to both upload their products and services into a 3D modeling/rendering software platform and also enter markets where 3D models/renderings are used for competition between entities to facilitate the construction, remodeling, manufacturing, designing, buying, and/or selling of homes, businesses, structures, vehicles, and/or buildings.

Another example, but not meant to be a limitation of the scope of the specification, would be for a user and/or individual or entity of a 3D modeling/rendering software platform implementing copyrighted art, pictures, designs, abstract art, trademarked constructs, and/or personal art or pictures into a 3D model/rendering of a home, business, structure, vehicle, and/or building that is being created and/or manipulated using said 3D modeling/rendering software platform. Owners of copyrighted and/or trademarked pieces of art, pictures, and/or designs will pay the licensor and licensee to have their respectively owned copyrighted and/or trademarked art, pictures, and/or designs uploaded into a 3D modeling/rendering software platform so that users and/or individuals or entities can pick, choose, and implement said art, pictures, and/or designs into a 3D model/rendering of a home, business, structure, vehicle, and/or building being created and/or manipulated within a 3D modeling/rendering software platform. The user and/or individual or entity would then send the newly created and/or manipulated 3D model/rendering with the implemented art, picture, and/or design to a virtual marketplace created by the 3D modeling/rendering software platform to a virtual marketplace where entities who specialize in painting and/or implementing said art, pictures, and/or designs into homes, businesses, structures, vehicles, and/or buildings and who have paid the licensor and licensee of a 3D modeling/rendering software platform to have the ability to give estimates, make bids, advertise and offer their products and services, create contracts, accept credit and/or monetary transactions, target geographical areas and consumer demographics, and/or seek out opportunities for such implementation of art, pictures, and/or designs into homes, businesses, structures, vehicles, and/or buildings will compete to implement said art, pictures, and/or designs into a home, business, structure, vehicle, and/or building.

Going further, but not meaning to be a limitation of the scope of this patent specification, a consumer may wish to have a design such as the Sistine Chapel ceiling painted onto a vaulted ceiling in their home, business, structure, vehicle, and/or building. A user and/or individual or entity would then either take uploaded construction, architectural, remodeling, manufacturing, and/or engineering schematics and/or plans and use applications within a 3D modeling/rendering software platform to convert them into a 3D model/rendering that can be manipulated within the software platform or create a new 3D model/rendering of the home, business, structure, vehicle, and/or building from scratch. The user and/or individual or entity would then implement a depiction of the Sistine Chapel ceiling that had been uploaded into a 3D modeling/rendering software platform into the 3D model/rendering of a vaulted ceiling in a home, business, structure, vehicle, and/or building and send the newly created and/or manipulated 3D model/rendering to a virtual marketplace created by the 3D modeling/rendering software platform where entities would compete for the facilitation of painting the Sistine Chapel ceiling onto the vaulted ceiling in the consumer's home, business, structure, vehicle, and/or building. This example shows how consumers can have desired products and services implemented into their home by first having a user and/or individual or entity create and/or manipulate a 3D model/rendering of their home, business, structure, vehicle, and/or building, implement the product and service into the 3D model/rendering, and then send the 3D model/rendering to a virtual marketplace where entities who specialize in such implementation of products and services will compete to facilitate the actual implementation of a product and service into a home, business, structure, vehicle, and/or building.

Yet another example of how the product, service, and/or market integration of 3D modeling/rendering software works, but not a limitation of the scope of the invention, would be a consumer wishing to have their subsequent home, business, structure, vehicle, and/or building remodeled. A user and/or individual or entity would either upload construction, architectural, remodeling, manufacturing, and/or engineering schematics and/or plans of the consumer's home, business, structure, vehicle, and/or building and use applications within a 3D modeling/rendering software platform to convert them into a 3D model/rendering that can be manipulated within the software platform or create a new 3D model/rendering of the home, business, structure, vehicle, and/or building from scratch using the construction, architectural, remodeling, manufacturing, and/or engineering schematics and/or plans. The consumer would specify what they wanted to have remodeled in their home, business, structure, vehicle, and/or building such as implementing products and services and/or changing the physical/spatial dimensions and dispositions of their home, business, structure, vehicle, and/or building. The user and/or individual or entity would then make the specified changes and/or add new products and services to the 3D model/rendering by manipulating it within the 3D modeling/rendering software platform. The newly created and/or manipulated 3D model/rendering with the specified changes and/or remodeled attributes would then be sent to a virtual marketplace created by the 3D modeling/rendering software platform where entities would compete for the actual facilitation of the remodeling of the consumer's home, business, structure, vehicle, and/or building.

An example of how a consumer can utilize product, service, and market integration of 3D modeling software platforms for a remodeling project, but not a limitation of the patent specification, would be for the consumer to have a user and/or individual or entity either upload and convert existing or yet to be discovered construction, architectural, remodeling, manufacturing, and/or engineering schematics and/or plans of the consumer's home, business, structure, vehicle, and/or building so that they can be manipulated with a 3D modeling/rendering software platform or have the user and/or individual or entity create a 3D model/rendering of the consumer's home, business, structure, vehicle, and/or building from scratch. The consumer would specify what new appliances, products, carpentry services, lighting schemes, and/or changes to the physical/spatial dimensions and dispositions they wanted in terms of the remodeling of their home, business, structure, vehicle, and/or building and then the user and/or individual or entity would manipulate the 3D model/rendering accordingly. Once the remodeled 3D model/rendering had all of the new products and services and changes to the physical/spatial dimensions and dispositions implemented into it according to the consumer's wishes, the user and/or individual or entity would send the 3D model/rendering to a virtual marketplace created by the 3D modeling/rendering software platform where entities would compete for the facilitation of the remodeling of the home, business, structure, vehicle and/or building and implementation of products and services.

Another example of how the product, service, and market integration of 3D modeling/rendering software could work, but not meant to be a limitation of the scope of this patent specification, would be for a consumer wishing to have a home, business, structure, vehicle, and/or building manufactured. The consumer would have a user and/or individual or entity upload existing or yet to be discovered construction, architectural, remodeling, manufacturing, and/or engineering schematics and/or plans into a 3D modeling/rendering software platform where applications would convert the schematics and/or plans into a 3D model/rendering that can be manipulated within the software platform or a user and/or individual or entity would create a 3D model/rendering of a home, business, structure, vehicle, and/or building from scratch using the schematics and/or plans as a guide. Once the 3D model/rendering of the home, business, structure, vehicle, and/or building is uploaded or created within the 3D modeling/rendering software platform, the consumer can specify what products and services they desire to go into a home, business, structure, vehicle, and/or building and the user and/or individual or entity would implement the products and services accordingly. The 3D model/rendering of the home, business, structure, vehicle, and/or building would then be sent to a virtual marketplace created by the 3D modeling/rendering where entities would compete for the facilitation of the manufacturing of the newly created and/or manipulated 3D model/rendering.

Going further, but not meant to be a limitation of the scope of this patent specification, would be for a consumer wishing to have a trailer manufactured for their personal residence. A user and/or individual or entity would upload existing or yet to be discovered construction, architectural, remodeling, manufacturing, and/or engineering schematics and/or plans into a 3D modeling/rendering software platform where applications within the software platform would convert the uploaded schematics and/or plans into a 3D model/rendering that could be manipulated within the software platform or a user and/or individual or entity would create a 3D model/rendering of the trailer from scratch using the schematics and/or plans. Once the 3D model/rendering of the trailer has been converted or created, the consumer will specify the particular physical/spatial dimensions and dispositions would want for the trailer and also add in any products and services they wish to be implemented once the trailer is manufactured. The user and/or individual or entity will then send the 3D model/rendering of the trailer to a virtual marketplace created by the 3D modeling/rendering software platform where entities associated with the manufacturing of trailers will compete for the business opportunity of manufacturing the trailer to the specified physical/spatial dimensions and dispositions of the consumer along with the products and services such as appliances, custom decor, and/or other products and services they specify for their trailer.

Another example of how the product, service, and market integration of 3D modeling/rendering software could work, but not meant to be a limitation of the scope of this patent specification, would be for a consumer wishing to have a home, business, structure, vehicle, and/or building designed to their own specifications or by a professional entity. The consumer could either start with existing or yet to be discovered construction, architectural, remodeling, manufacturing, and/or engineering schematics and/or plans that are uploaded into a 3D modeling/rendering software platform and converted to a 3D model/rendering that can be manipulated into a design they desire or the consumer could have a user and/or individual or entity or in some cases the consumer could create, manipulate, and/or design a home business, structure, vehicle, and/or building if they have experience using a 3D modeling/rendering software platform. In any instance, the consumer and/or user and/or individual or entity would design a home, business, structure, vehicle, and/or building using applications within a 3D modeling/rendering software platform and design the physical/spatial dimensions and dispositions as well as implement the types and brands of products and services that would fit best into the design they are seeking within the 3D model/rendering of the home, business, structure, vehicle, and/or building. The consumer or user and/or individual or entity would then send the 3D model/rendering of the newly designed home, business, structure, vehicle, and/or building to a virtual marketplace where entities would compete for the facilitation of the designing of the consumer's home, business, structure, vehicle, and/or building according to the consumers specifications for the designs.

Going further, but not meant to be a limitation of the scope of this patent specification, a consumer may wish to have a building designed using a 3D modeling/rendering software platform. A user and/or individual or entity would create and/or manipulate a 3D model/rendering of the building using applications of a 3D modeling/rendering software platform according to the consumer's particular specifications including the physical/spatial dimensions and dispositions of the building as well as the various existing or yet to be discovered products and services that the consumer wanted to be implemented into the building. Once the building has the specified physical/spatial dimensions and dispositions as well as the products and services that the consumer specifies, the user and/or individual or entity will send the newly created and/or manipulated 3D model/rendering of the building to a virtual marketplace that is created by applications within the 3D modeling/rendering software program where entities will compete for the facilitation of the construction, remodeling, manufacturing, designing, buying, and/or selling of the building as well as the buying and selling of products and services that the consumer has specified to be implemented into the building.

Another example of how the product, service, and market integration of 3D modeling/rendering software could work, but not meant to be a limitation of the scope of this patent specification, would be for a consumer and/or entity wanting to buy a home, business, structure, vehicle, and/or building. The consumer would specify to the seller what changes to the products and services and physical/spatial dimensions and dispositions of the home, business, structure, vehicle, and/or building were needed before purchase. In other instances, a buyer of a home, business, structure, vehicle, and/or building will make the purchase and then decide to implement new products and services and/or change the physical/spatial dimensions and dispositions. In either instance, the buyer and/or seller would then have a user and/or individual or entity either upload the existing construction, architectural, remodeling, manufacturing, and/or engineering schematics and/or plans into a 3D modeling/rendering software platform where they could be manipulated or the user and/or individual or entity would create a new 3D model/rendering of the home, business, structure, vehicle, and/or building from scratch. The user and/or individual or entity would then manipulate the 3D model/rendering according to the buyer and/or seller's specifications and changes by implementing products and services and/or changing the physical/spatial dimensions and dispositions of the home, business, structure, vehicle, and/or building. The user and/or individual or entity would then send the newly created and/or manipulated 3D model/rendering to a virtual marketplace where entities would compete for the facilitation of the changes and/or specifications that the buyer of the home has specified.

Going further, but not meant to be a limitation of the scope of this patent specification, an example of how a homebuyer would use the product, service, and market integration of 3D modeling/rendering software platforms follows. The homebuyer purchases a home and decides to implement new products and services into the home and/or change the physical/spatial dimensions and dispositions of the home. The homebuyer would either have a user and/or individual or entity upload existing construction, architectural, remodeling, manufacturing, and/or engineering schematics and/or plans of the home into a 3D modeling/rendering software platform where they could be manipulated or the user and/or individual or entity would create a new 3D model/rendering of the home from scratch using applications within a 3D modeling/rendering software platform. The homebuyer would specify what products and services to be implemented into the home and the user and/or individual or entity would implement the products and services into the 3D model/rendering of the home being manipulated within the 3D modeling/rendering software platform. Also, the homebuyer would specify any changes to the physical/spatial dimensions of the home to the user and/or individual or entity and these changes would be made to the 3D model/rendering of the home being manipulated within the 3D modeling/rendering software platform. Once the homebuyer has chosen the products and services to be implemented into their new home and specified the changes to the physical/spatial dimensions and dispositions of the home and the user and/or individual or entity has manipulated the 3D model/rendering of the home accordingly, then the user and/or individual or entity would send the newly manipulated 3D model/rendering to a virtual marketplace created by the 3D modeling/rendering software platform. Various entities would then compete for the facilitation of the implementation of the products and services into the home as well as the facilitation of the changes to the physical/spatial dimensions and dispositions of the home.

Another example of how the product, service, and market integration of 3D modeling/rendering software could work, but not meant to be a limitation of the scope of this patent specification, would be for an entity wanting to sell a home, business, structure, vehicle, and/or building. The seller would specify what products and services should be implemented into the home, business, structure, vehicle, and/or building that would make it more marketable and specify any needed changes to the physical/spatial dimensions and dispositions of the home, business, structure, vehicle, and/or building before putting the home, business, structure, vehicle, and/or building on the market. The seller would then have a user and/or individual or entity of a 3D modeling/rendering software platform either upload the existing construction, architectural, remodeling, manufacturing, and/or engineering schematics and/or plans of the home, business, structure, vehicle, and/or building into a 3D modeling/rendering software platform where it could be manipulated or the user and/or individual or entity would create a new 3D model/rendering of the home, business, structure, vehicle, and/or building from scratch. The user and/or individual or entity would then manipulate the 3D model/rendering according to the seller's specifications and make changes by implementing products and services and/or changing the physical/spatial dimensions and dispositions of the home, business, structure, vehicle, and/or building before putting it onto the market. The user and/or individual or entity would then send the newly created and/or manipulated 3D model/rendering to a virtual marketplace where entities would compete for the facilitation of the changes and/or specifications of the seller.

Going further, but not meant to be a limitation of the scope of this patent specification, an example of how a seller of a home, business, structure, vehicle, and/or building would use the product, service, and market integration of 3D modeling/rendering software platforms follows. A seller would wish to put a home, business, structure, vehicle, and/or building on the market after having new products and services as well as changes to the physical/spatial dimension of the home, business, structure, vehicle, and/or building were made. The seller would either have a user and/or individual or entity upload existing construction, architectural, remodeling, manufacturing, and/or engineering schematics and/or plans of the home, business, vehicle, structure, and/or building uploaded into a 3D modeling/rendering software platform where it could be manipulated or the user and/or individual or entity would create a new 3D model/rendering of the home, business, structure, vehicle, and/or building from scratch using applications within a 3D modeling/rendering software platform. The seller would specify what products and services were to be implemented into the home and the user and/or individual or entity would implement the products and services into the 3D model/rendering of the home being manipulated within the 3D modeling/rendering software platform. Also, the seller would specify any changes to the physical/spatial dimensions of the home, business, structure, vehicle, and/or building to the user and/or individual or entity and these changes would be made to the 3D model/rendering of the home being manipulated within the 3D modeling/rendering software platform. Once the seller has chosen the products and services to be implemented into the home, business, structure, vehicle, and/or building and specified the changes to the physical/spatial dimensions and dispositions and the user and/or individual or entity has manipulated the 3D model/rendering accordingly, then the user and/or individual or entity would send the newly manipulated 3D model/rendering to a virtual marketplace created by the 3D modeling/rendering software platform. Various entities would then compete for the facilitation of the implementation of the products and services into the home, business, structure, vehicle, and/or building as well as the facilitation of the changes to the physical/spatial dimensions and dispositions. The seller would then be able to put the home, business, structure, vehicle, and/or building on the market with its updated products and services as well as the new physical/spatial dimensions and dispositions.

In conclusion, this integration of products, services, and markets into 3D modeling/rendering software platforms will allow for users and/or individuals or entities to have the ability to implement the entire spectrum of existing or yet to be discovered products and services into a 3D model/rendering of a home, business, structure, vehicle, and/or building that is being created and/or manipulated within a 3D modeling/rendering software platform. This will allow for users and/or individuals or entities to be able to pick, choose, implement, and visually see how a product or service will actually look if it were to be implemented into a home, business, structure, vehicle, and/or building. Entities buy and sell products and services will be able to upload their subsequent products and services into a 3D modeling/rendering software platform where users and/or individuals or entities will be implement them into a 3D model/rendering. This allows for new markets to be created and more competition between entities for business. Users and/or individuals or entities will also be able to make changes and/or additions to 3D models/renderings and entities will be able to compete for those associated products and services. Also, entities associated with the construction, remodeling, manufacturing, designing, buying, and/or selling of homes, businesses, structures, vehicles, and/or buildings will have the ability to compete for the facilitation of implementing products and services and changes and additions to homes, businesses, structures, vehicles, and/or buildings that are created and/or manipulated within a 3D modeling/rendering software platform. These entities will compete for the facilitation and implementation of products, services, changes, and additions once the created and/or manipulated 3D model/rendering has been sent to a virtual marketplace. Entities who upload products and services and entities who compete for various facilitation and implementation projects will pay the licensor and/or licensee of the patent for the abilities and opportunities created by the integration of products, services, and markets within existing and/or yet to be discovered 3D modeling/rendering software platforms.

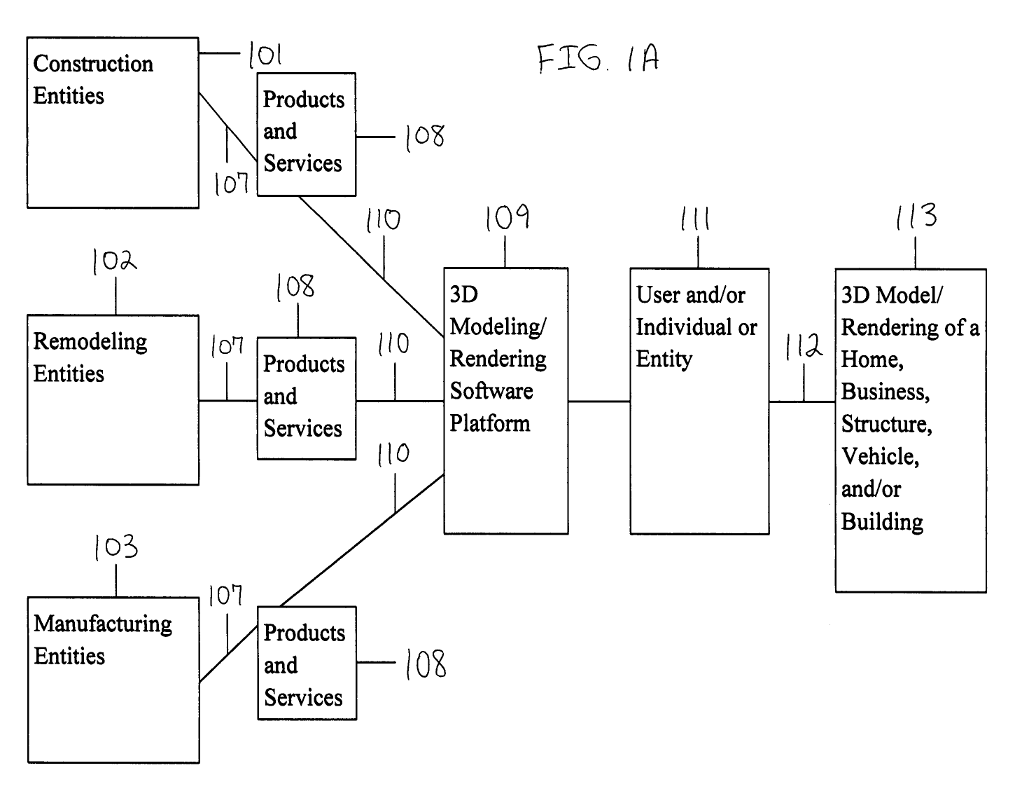

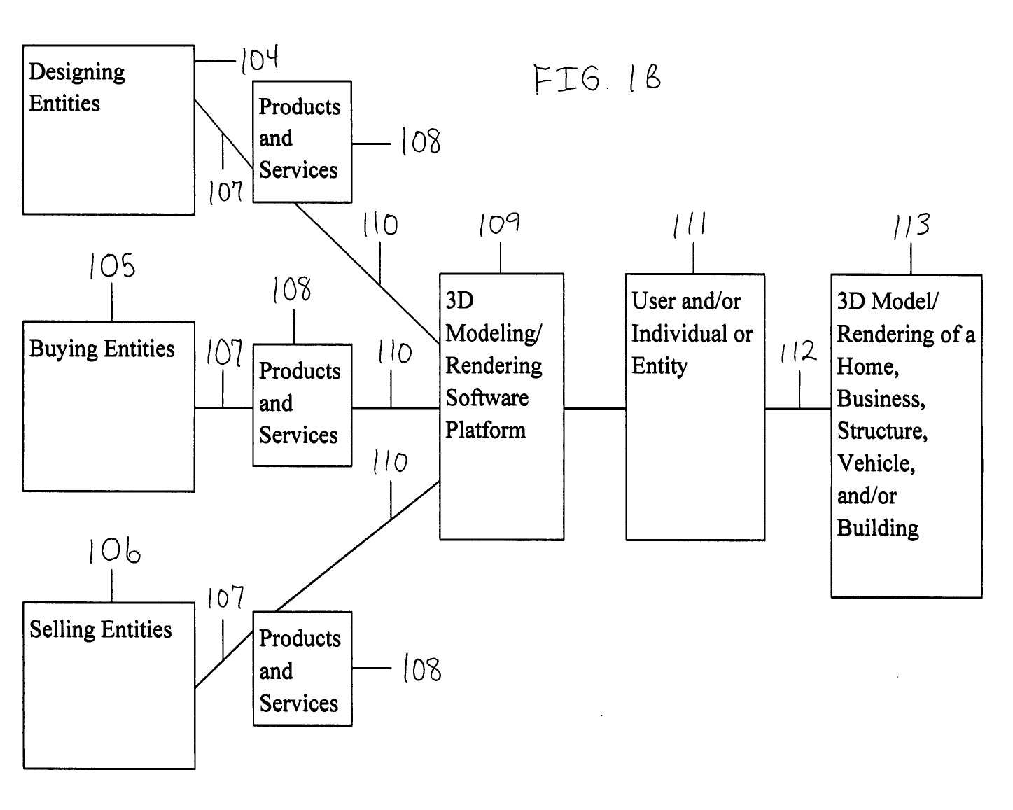

### Operation of Invention—FIGS. 1A, 1B, 2, 3, 4A, 4B, 4C, 4D, 5A, 5B, 6A, 6B, 7A, and 7B

FIG. 1A. Construction entities (101), remodeling entities (102), and/or manufacturing entities (103) associated with the buying and/or selling of products and services needed in the construction, remodeling, manufacturing, designing, buying, and/or selling of homes, businesses, structures, vehicles, and/or buildings will upload (107) their subsequent products and services (108) into an existing or yet to be discovered 3D modeling/rendering software platform (109) by means of a direct, secure, and electronic linkage (110). Thereby, a user and/or individual or entity (111) of said 3D modeling/rendering software platform (109) will be able to implement (112) the uploaded products and services (108) into a 3D model/rendering of a home, business, structure, vehicle, and/or building (113) that is being created and/or manipulated by the user and/or individual or entity (111) using the applications of said 3D modeling/rendering software platform (109).

FIG. 1B. Designing entities (104), buying entities (105), and/or selling entities (106) associated with the buying and/or selling of products and services needed in the construction, remodeling, manufacturing, designing, buying, and/or selling of homes, businesses, structures, vehicles, and/or buildings will upload (107) their subsequent products and services (108) into an existing or yet to be discovered 3D modeling/rendering software platform (109) by means of a direct, secure, and electronic linkage (110). Thereby, a user and/or individual or entity (111) of said 3D modeling/rendering software platform (109) will be able to implement (112) the uploaded products and services (108) into a 3D model/rendering of a home, business, structure, vehicle, and/or building (113) that is being created and/or manipulated by the user and/or individual or entity (111) using the applications of said 3D modeling/rendering software platform (109).

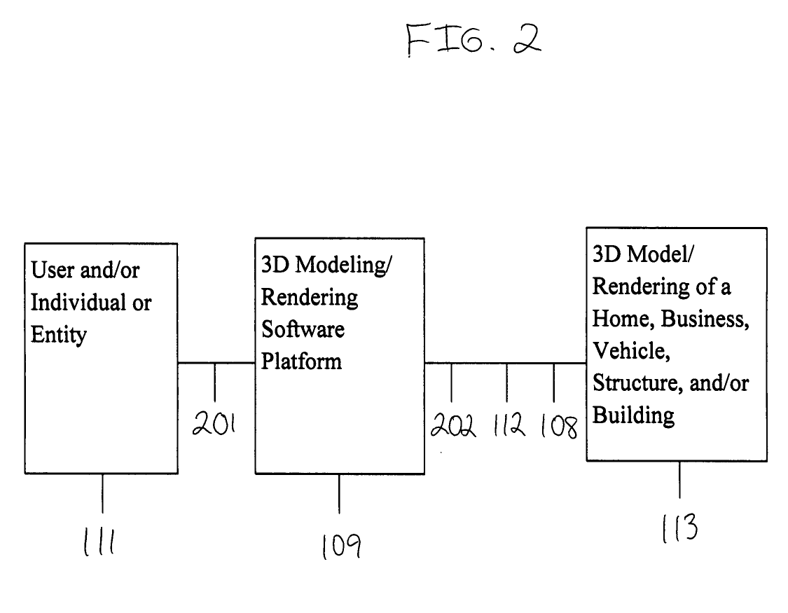

FIG. 2. The user and/or individual or entity (111) interfaces (201) with the 3D modeling/rendering software platform (109) to create and/or manipulate (202) a 3D model/rendering of a home, business, structure, vehicle, and/or building (113) and implements (112) products or services (108) at their own volition and can choose from the various differing types of existing or yet to be discovered products or services (108) of entities associated with the construction, remodeling, manufacturing, designing, buying, and/or selling of homes, businesses, structures, vehicles, and/or buildings that have been uploaded into the 3D modeling/rendering software platform.

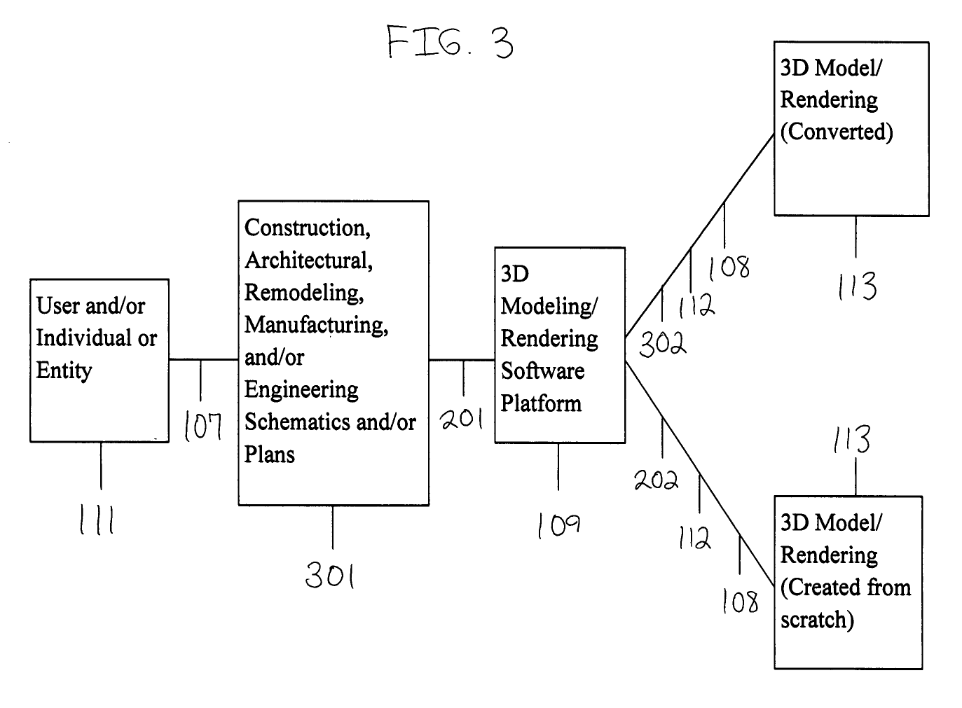

FIG. 3. This figure is a flowchart of an embodiment of an example of a user and/or individual or entity (111) uploading (107) construction, architectural, remodeling, manufacturing, and/or engineering schematics and/or plans (301) of a home, business, structure, vehicle, or building into a 3D modeling/rendering software platform (109) whereby the user and/or individual or entity (111) can implement (112) products and services (108) into the 3D model/rendering of a home, business, structure, vehicle, and/or building (113) at their own volition. The 3D modeling/rendering software platform (109) can either have applications that can convert (302) the existing or yet to be discovered construction, architectural, remodeling, manufacturing, and/or engineering schematics and/or plans (301) into a 3D model/rendering (113) within the 3D modeling/rendering software platform (109) or in other instances a user and/or individual or entity (111) will have to create and/or manipulate (202) a 3D model/rendering (113) from scratch using existing or yet to be discovered construction, architectural, remodeling, manufacturing, and/or engineering schematics and/or plans (301) and applications of a 3D modeling/rendering software platform (109). In either instance, once the schematics and/or plans (301) have been converted (302) or created and/or manipulated (202) using applications within a 3D modeling/rendering software platform (109), the user and/or individual or entity (111) will be able to implement (112) products or services (108) into a 3D model/rendering (113) by interfacing (201) with a 3D modeling/rendering software platform (109).

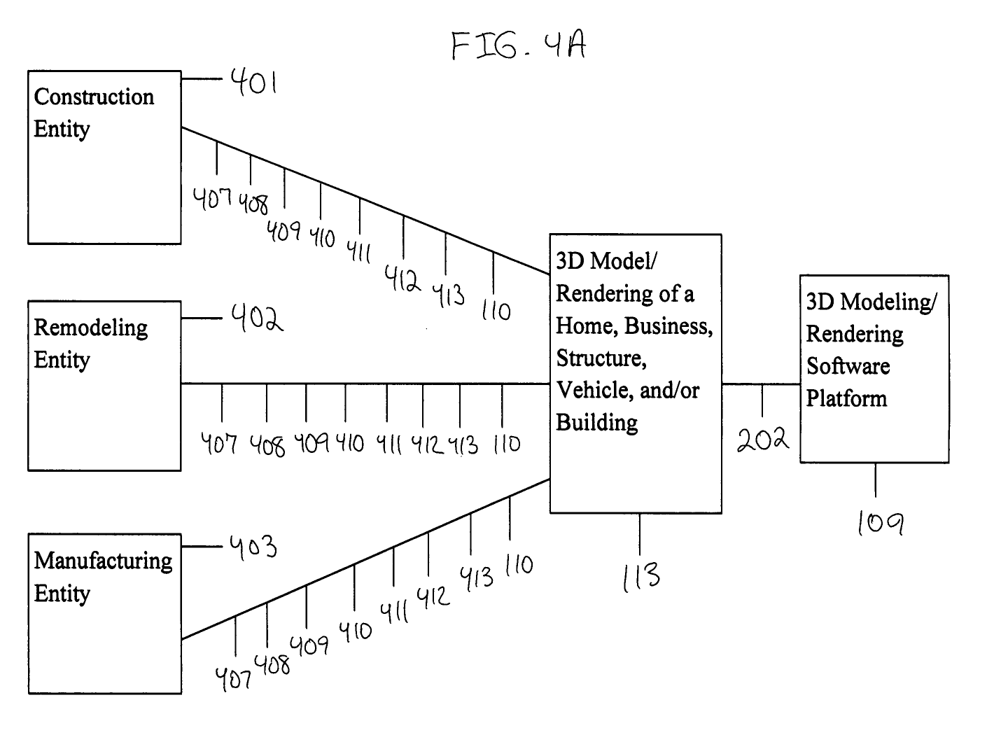

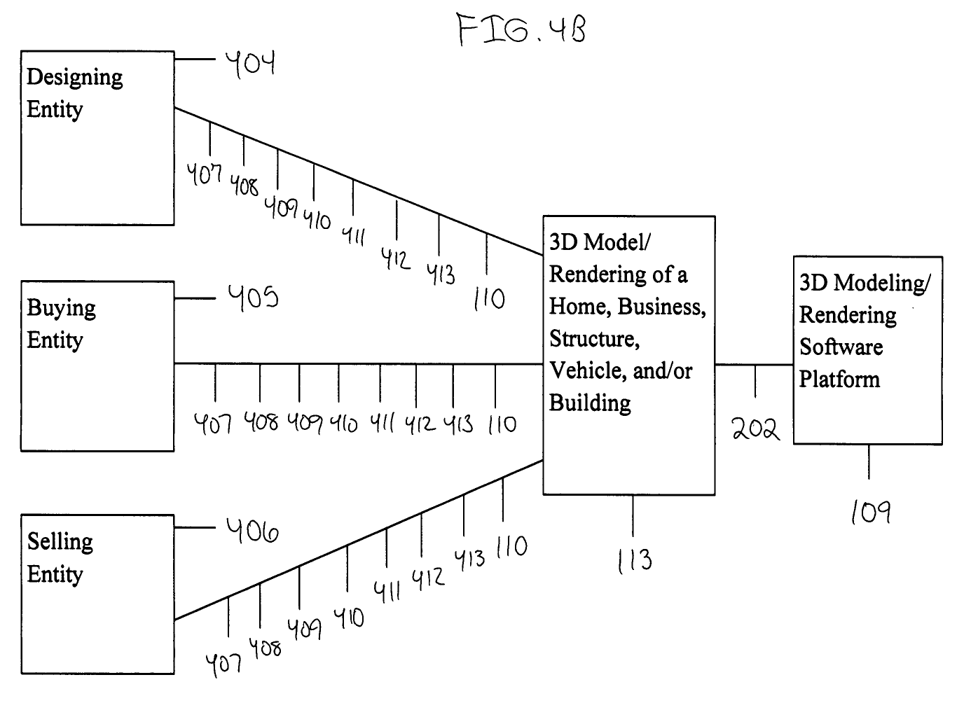

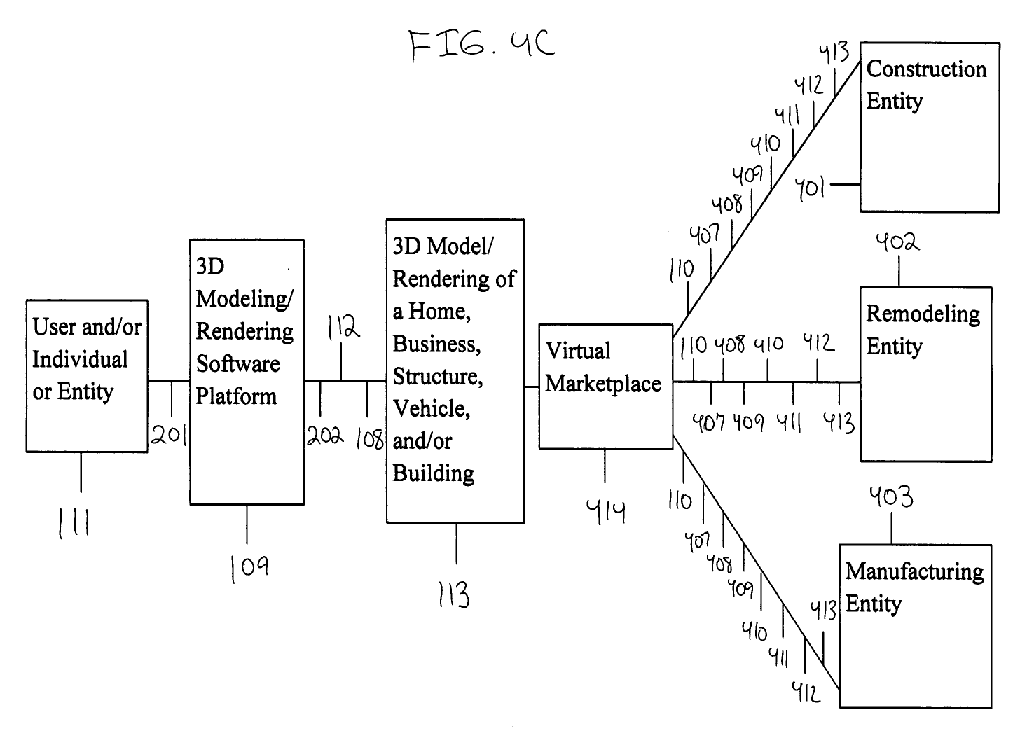

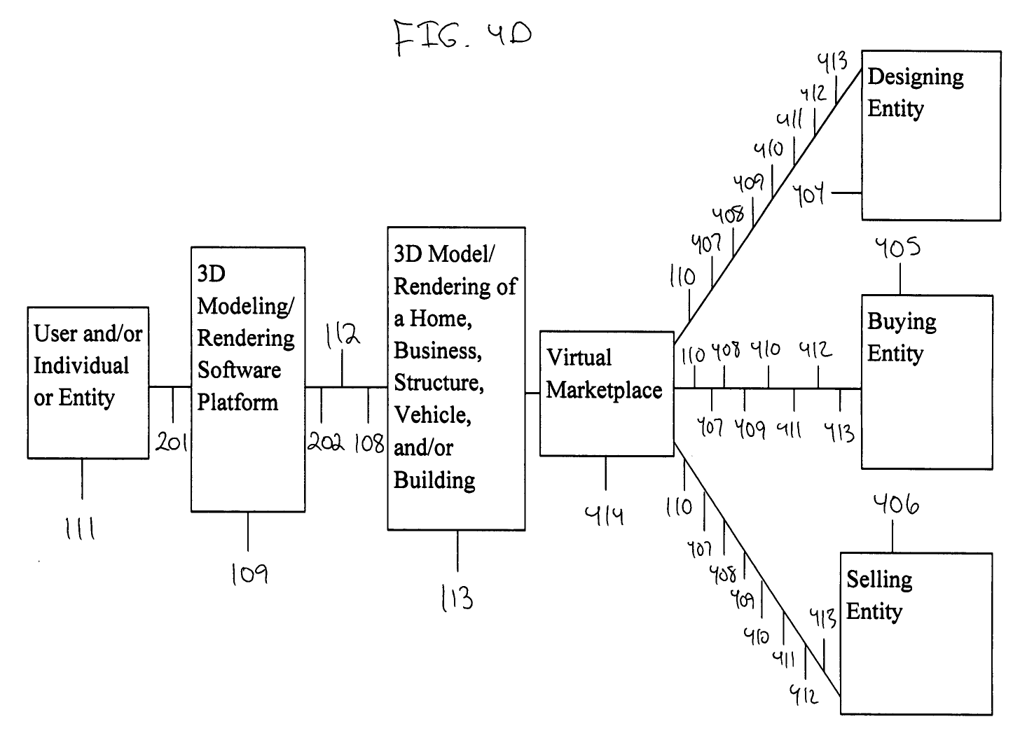

FIG. 4A. The figure is a flowchart of an embodiment of an example of an entity associated with the construction (401), remodeling (402), and/or manufacturing (403) of homes, businesses, structures, vehicles, and/or buildings having the ability to be able to give estimates for (407), make bids for (408), advertise and offer their products and services for (409), create contracts for (410), accept credit and/or monetary transactions for (411), target geographical areas and consumer demographics for (412), and/or seek out business opportunities for (413) the construction, remodeling, manufacturing, designing, buying, and/or selling of a home, business, structure, vehicle, and/or building that is created and/or manipulated (202) as a 3D model/rendering (113) within an existing or yet to be discovered 3D modeling/rendering software platform (109) through direct, secure, and electronic linkages (110) between the entities (401-403) and the 3D modeling/rendering software platform (109).

FIG. 4B. The figure is a flowchart of an embodiment of an example of an entity associated with the designing (404), buying (405), and/or selling (406) of homes, businesses, structures, vehicles, and/or buildings having the ability to be able to give estimates for (407), make bids for (408), advertise and offer their products and services for (409), create contracts for (410), accept credit and/or monetary transactions for (411), target geographical areas and consumer demographics for (412), and/or seek out business opportunities for (413) the construction, remodeling, manufacturing, designing, buying, and/or selling of a home, business, structure, vehicle, and/or building that is created and/or manipulated (202) as a 3D model/rendering (113) within an existing or yet to be discovered 3D modeling/rendering software platform (109) through direct, secure, and electronic linkages (110) between the entities (404-406) and the 3D modeling/rendering software platform (109).

FIG. 4C. This figure is a flowchart of an embodiment of an example that shows how a user and/or individual or entity (111) interfaces (201) with a 3D modeling/rendering software platform (109) to create and/or manipulate (202) a 3D model/rendering of a home, business, structure, vehicle, and/or building (113) and implements (112) uploaded products and services (108) into the 3D model/rendering (113). The 3D model/rendering (113) will then be sent to a virtual marketplace (414) via a direct, secure, and electronic linkage (110) where construction entities (401), remodeling entities (402), and/or manufacturing entities (403) can give estimates for (407), make bids for (408), advertise and offer their products and services for (409), create contracts for (410), accept credit and/or monetary transactions for (411), target geographical areas and consumer demographics for (412), and/or seek out business opportunities for (413) the construction, remodeling, manufacturing, designing, buying, and/or selling of homes, businesses, structures, vehicles, and/or buildings that are created and/or manipulated (202) as a 3D model/rendering (113) within a 3D modeling/rendering software platform.

FIG. 4D. This figure is a flowchart of an embodiment of an example that shows how a user and/or individual or entity (111) interfaces (201) with a 3D modeling/rendering software platform (109) to create and/or manipulate (202) a 3D model/rendering of a home, business, structure, vehicle, and/or building (113) and implements (112) uploaded products and services (108) into the 3D model/rendering (113). Applications within the 3D modeling/rendering software platform will then create a virtual marketplace (414) for the 3D model/rendering (113) where designing entities (404), buying entities (405), and/or selling entities (406) can give estimates for (407), make bids for (408), advertise and offer their products and services for (409), create contracts for (410), accept credit and/or monetary transactions for (411), target geographical areas and consumer demographics for (412), and/or seek out business opportunities for (413) the construction, remodeling, manufacturing, designing, buying, and/or selling of homes, businesses, structures, vehicles, and/or buildings that are created and/or manipulated (202) as a 3D model/rendering (113) within a 3D modeling/rendering software platform (109) using direct, secure, and electronic linkages (110).

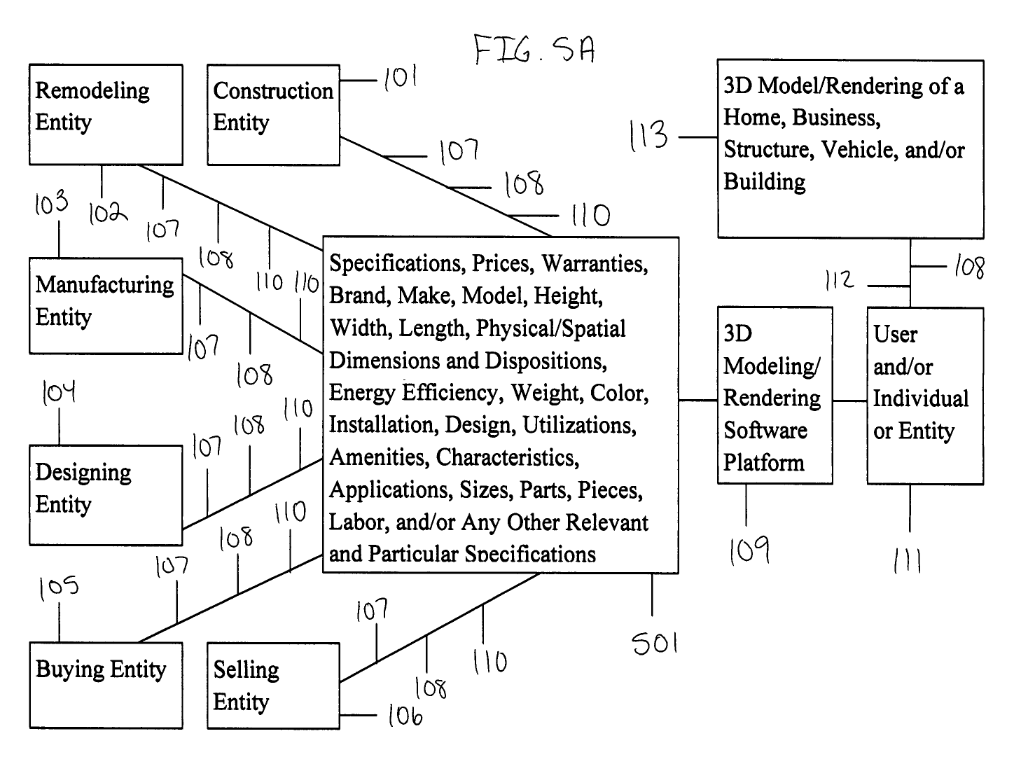

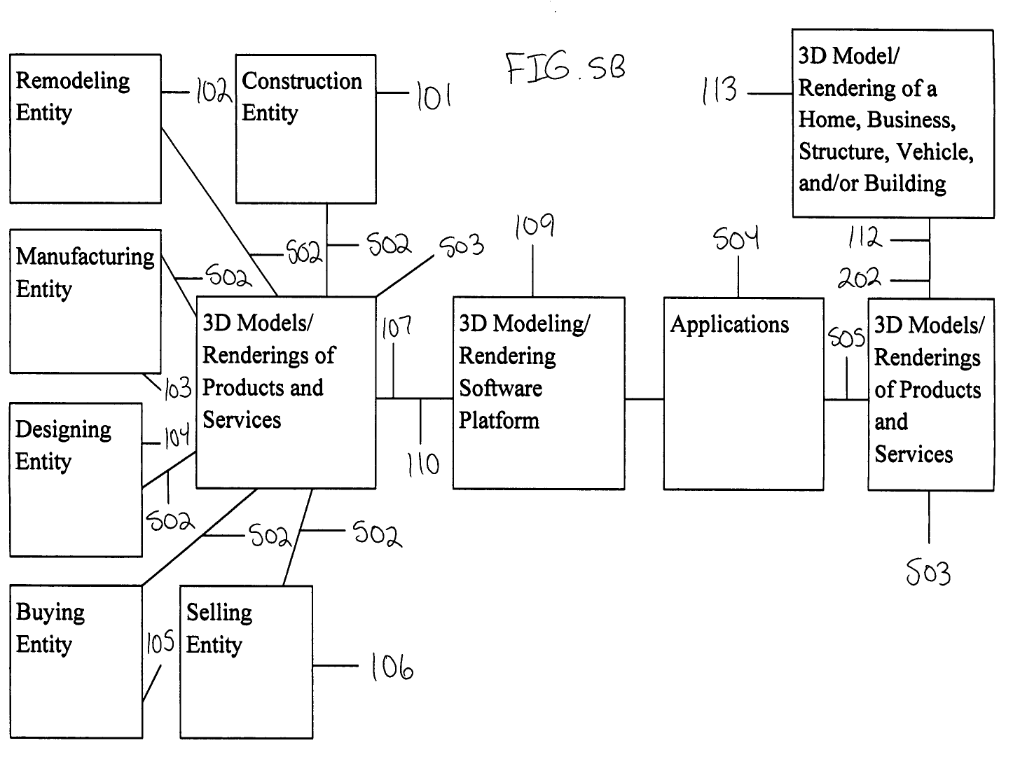

FIG. 5A. This figure is a flowchart of an embodiment of an example of a construction entity (101), remodeling entity (102), manufacturing entity (103), designing entity (104), buying entity (105), or selling entity (106) uploading (107) various products and services (108) into a 3D modeling/rendering software platform (109) via a direct, secure, and electronic linkage (110) will include the specifications, prices, warranties, brand, make, model, height, width, length, physical/spatial dimensions and dispositions, energy efficiency, weight, color, installation, design, utilizations, amenities, characteristics, applications, sizes, parts, pieces, labor, and/or any other relevant and particular specifications (501) so that the user and/or individual or entity (111) implementing (112) the products and services (108) into a 3D model/rendering (113) will be able to see how the products and services will actually look within the physical/spatial dimensions and dispositions of the 3D model/rendering that is being created and/or manipulated within a 3D modeling/rendering software platform.

FIG. 5B. This figure is a flowchart of an embodiment of an example of how a construction entity (101), remodeling entity (102), manufacturing entity (103), designing entity (104), buying entity (105), or selling entity (106) can create (502) 3D models/renderings of the products and services (503) they wish to upload (107) via a direct, secure, and electronic linkage (110) into a 3D modeling/rendering software platform (109). Then, applications (504) within a 3D modeling/rendering software program (109) can convert (505) 3D models/renderings of products and services created and uploaded by entities (503) into visualizations that will show how the products and services will look once implemented (112) into a 3D model/rendering of a home, business, structure, vehicle, and/or building (113) that is being created and/or manipulated (202) within a 3D modeling/rendering software platform (109).

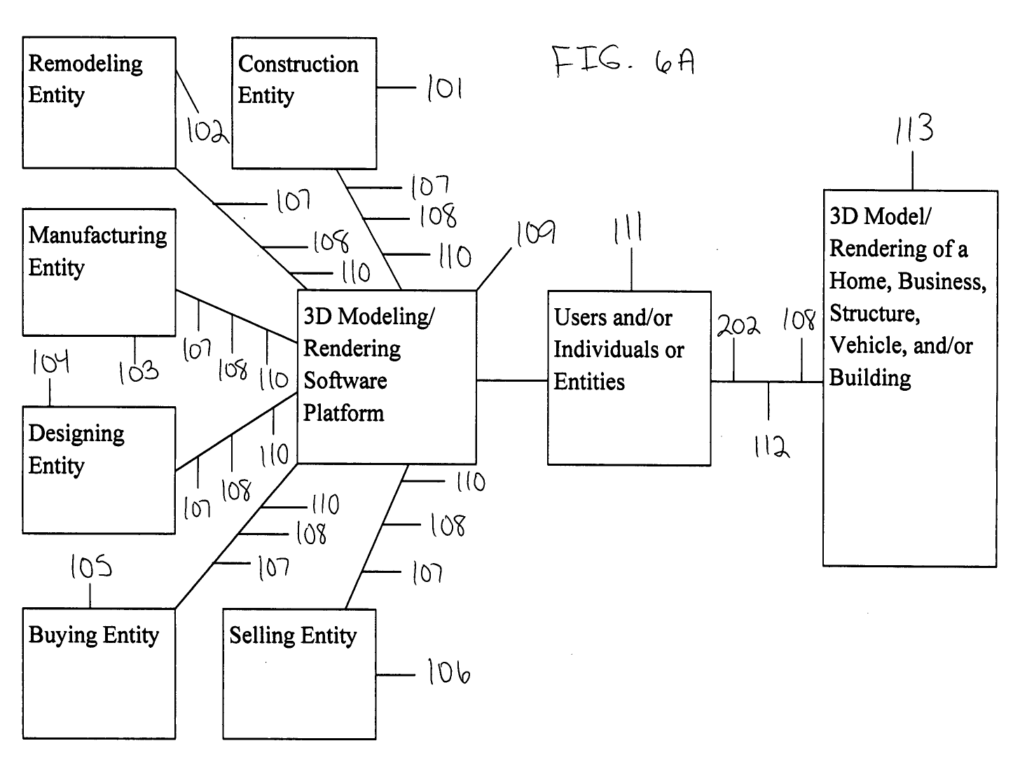

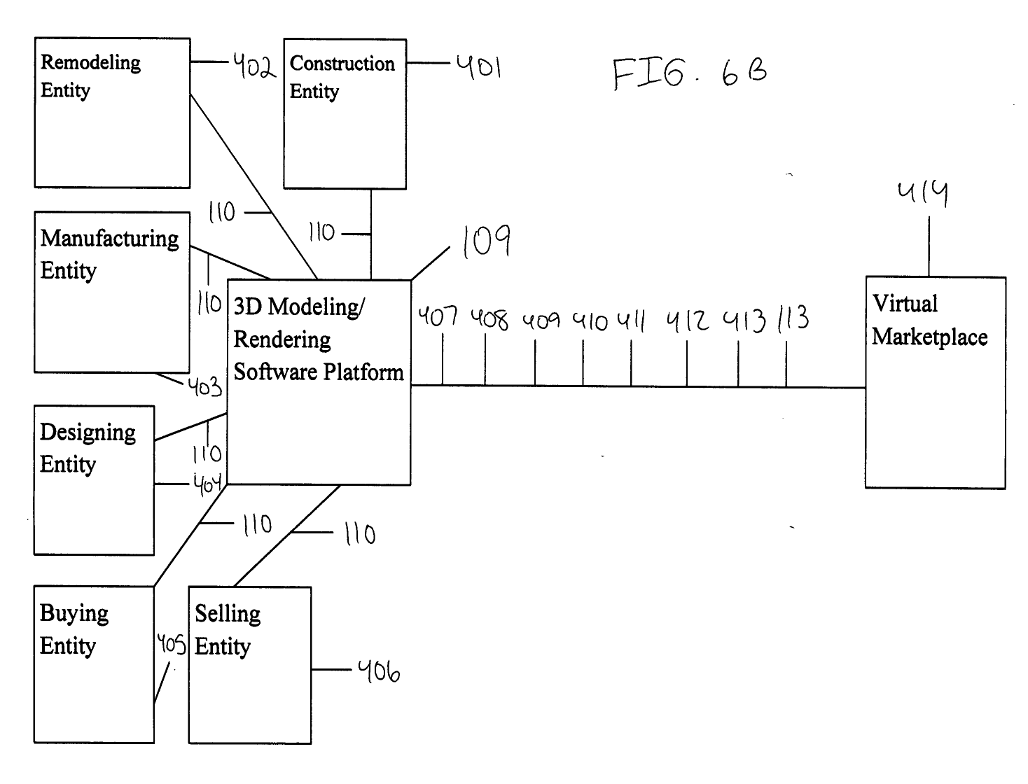

FIG. 6A. This figure is a flowchart of an embodiment of an example of how secure, direct, and electronic linkages (110) will be created between a 3D modeling/rendering software platform (109) and a construction entity (101), remodeling entity (102), manufacturing entity (103), designing entity (104), buying entity (105), or selling entity (106) associated with buying and/or selling of products or services within markets associated with the construction, remodeling, manufacturing, designing, buying, and/or selling of homes, businesses, structures, vehicles, and/or buildings. These direct, secure, and electronic linkages (110) between a 3D modeling/rendering software platform (109) and entities (101-106) allow for said entities to upload (107) their products or services (108) into a 3D modeling/rendering software platform (109) whereby users and/or individuals or entities (111) will be able to implement (112) said products or services (108) into a 3D model/rendering of a home, business, structure, vehicle, and/or building (113) that is being created and/or manipulated (202) with a 3D modeling/rendering software platform (109). The linkage (110) also allows for entities (101-106) to upload (107) new products or services as they are created and remove products or services that are discontinued or no longer bought and/or sold by an entity.

FIG. 6B. This figure is a flowchart of an embodiment of an example of how secure, direct, and electronic linkages (110) will be created between a 3D modeling/rendering software platform (109) and entities associated with the construction (401), remodeling (402), manufacturing (403), designing (404), buying (405), and/or selling (406) of homes, businesses, structures, vehicles, and/or buildings. These direct, secure, and electronic linkages between a 3D modeling/rendering software platform and various entities serve the purpose of allowing said entities to be able to give estimates for (407), make bids for (408), advertise and offer their products and services for (409), create contracts for (410), accept credit and/or monetary transactions for (411), target geographical areas and consumer demographics for (412), and/or seek out business opportunities for (413) the construction, remodeling, manufacturing, designing, buying, and/or selling of a home, business, structure, vehicle, and/or building that is created and/or manipulated as a 3D model/rendering (113) after it is sent to a virtual marketplace (414).

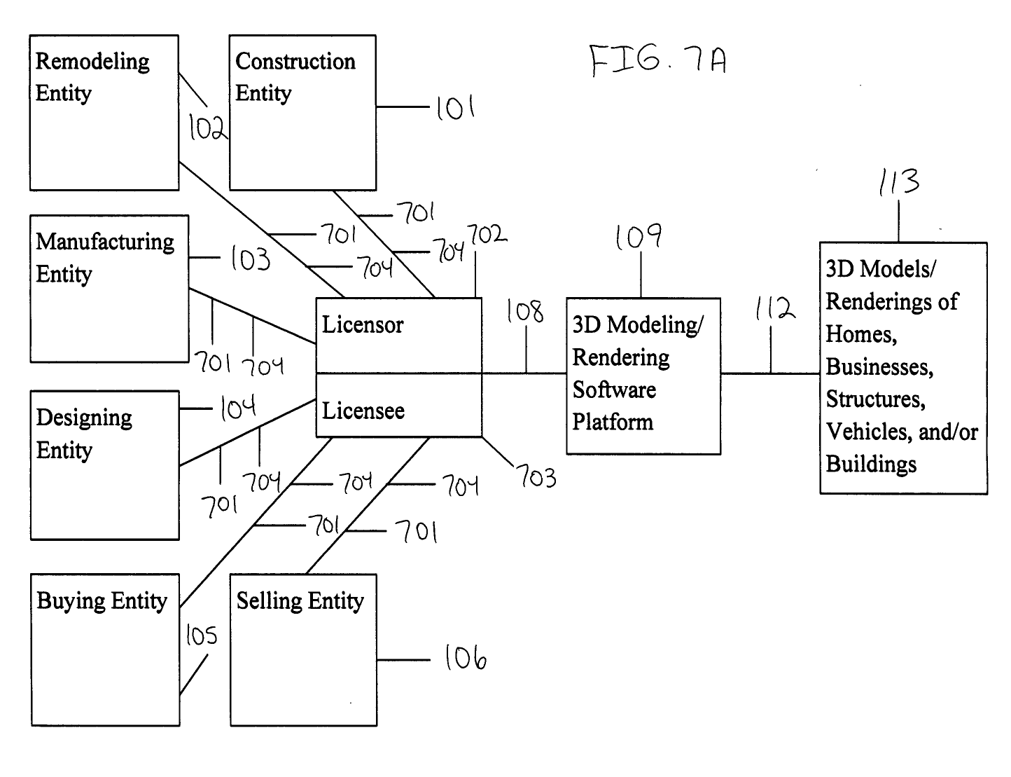

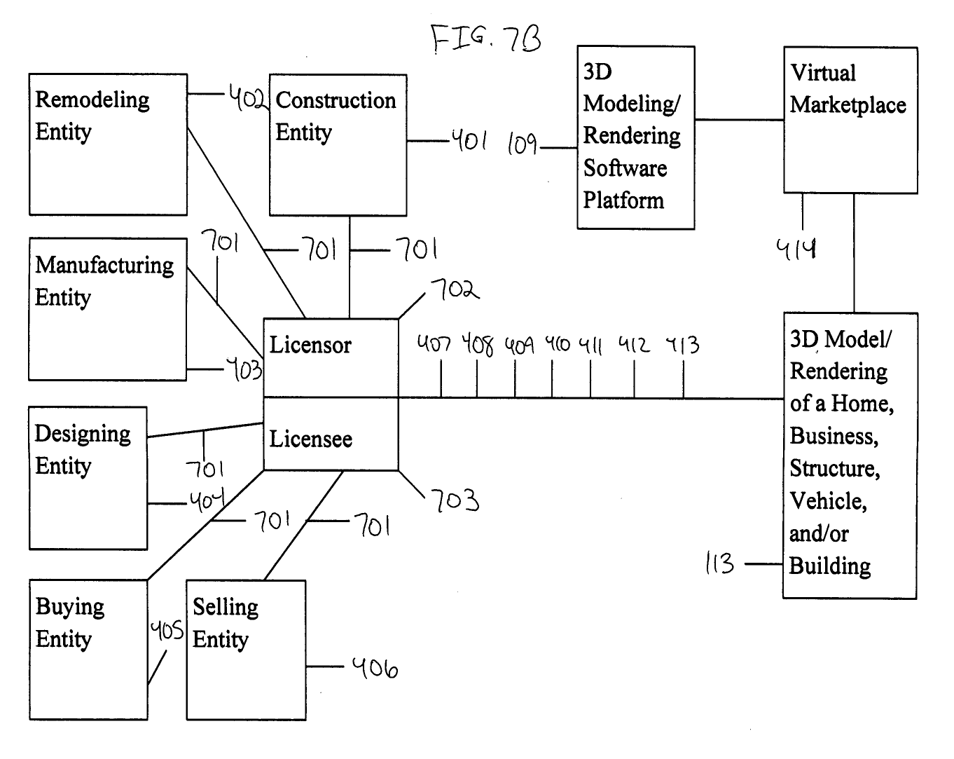

FIG. 7A. This figure is a depiction of an embodiment of an example of how entities associated with the buying and/or selling of products and services within the markets of construction (101), remodeling (102), manufacturing (103), designing (104), buying (105), and/or selling (106) of homes, businesses, structures, vehicles, and/or buildings will pay (701) the licensor (the inventor) (702) and licensee (703) (an entity associated with the 3D modeling/rendering software industry) to have their products or services (108) made available within a 3D modeling/rendering software platform (109) so that they can be implemented (112) them into 3D models/renderings of homes, businesses, structures, vehicles, and/or buildings (113) within a 3D modeling/rendering software platform (109). Entities (101-106) will also pay (701) the licensor (702) and licensee (703) a percentage of all sales and advertising revenue (704) generated from integration of markets, products, and services within 3D modeling/rendering software platforms (109).

FIG. 7B. This figure is a depiction of an embodiment of an example of how entities associated with the construction (401), remodeling (402), manufacturing (403), designing (404), buying (405), and/or selling (406) of homes, businesses, structures, vehicles, and/or buildings will pay (701) the licensor (the inventor) (702) and licensee (703) (an entity associated with the 3D modeling/rendering software industry) to have the potential to give estimates for (407), make bids for (408), advertise and offer their products and services for (409), create contracts for (410), accept credit and/or monetary transactions for (411), target geographical areas and consumer demographics for (412), and/or seek out business opportunities for (413) the construction, remodeling, manufacturing, designing, buying, and/or selling of a home, business, structure, vehicle, and/or building that is created and/or manipulated as a 3D model/rendering (113) within a 3D modeling/rendering software platform (109) and sent to a virtual marketplace (414).

### CONCLUSION, RAMIFICATIONS, AND SCOPE OF THE INVENTION

While the above description contains many specificities, these should not be construed as limitations on the scope of the invention, but rather as an exemplification of one preferred embodiment thereof. Some variations could be possible. There are many existing 3D modeling/rendering software platforms that contain many different kinds of applications. There are many different kinds of products, services, and markets that exist or that have yet been discovered that may not be covered in the specification. There are many different ways to write the code needed to facilitate the kinds of applications covered in this specification. There are many ways to implement objects, services, and lighting schemes into 3D models/renderings. Direct, secure, and electronic linkages between respective servers and networks can be created in many ways. The secure transmission of data, information, and 3D models/renderings across such linkages can be facilitated in a myriad of fashions and can be encrypted at differing bit levels. The creation of web-based interfaces and virtual marketplaces can be facilitated in many different ways. There are many different commercial entities that can create different kinds 3D models/renderings of various existing and yet to be discovered products and services. There are many techniques to create 3D models/renderings of products and services and implement them in 3D models/renderings. There are other types of existing and yet to be discovered homes, businesses, vehicles, structures, and/or buildings that can be created and/or manipulated within 3D model/rendering software platforms that are not covered in this specification.

I claim:

1. Processes for three dimensional modeling/rendering software programs that comprise:
Applications that allow commercial entities to upload three dimensional models/renderings of products and services into three dimensional modeling/rendering software platforms;
Applications that create direct, secure, and electronic linkages between three dimensional modeling/rendering software platforms and servers and/or networks of various commercial entities;
Applications that allow for users of three dimensional modeling/rendering software platforms to implement three dimensional models/renderings of products and services into three dimensional models/renderings of homes, businesses, vehicles, structures, and/or buildings;
Applications that allow for users of three dimensional software platforms to send three dimensional models/renderings of homes, businesses, vehicles, structures, and/or buildings to a virtual marketplace;
Applications that allow for the creation of a direct, secure, and electronic linkage between a virtual marketplace and commercial entities where said entities can seek out business opportunities related to three dimensional models/renderings of homes, businesses, vehicles, structures, and/or buildings;
Applications that allow for users to convert architectural plans and engineering schematics of homes, businesses, vehicles, structures, and/or buildings into three dimensional models/renderings;
Applications that allow for users to create and/or manipulate three dimensional models/renderings of homes, businesses, vehicles, structures, and/or buildings and implement existing and yet to be discovered products and services into said three dimensional models/renderings;

2. A process in claim 1 wherein commercial entities will create three dimensional models/renderings of their subsequent products and services.

3. A process in claim 1 wherein commercial entities will upload three dimensional models/renderings of their subsequent products and services to a three dimensional modeling/rendering software platform.

4. A process in claim 3 wherein the uploading of three dimensional models/rendering of products and services will be facilitated by a direct, secure, and electronic linkage between the respective servers and/or networks of commercial entities and users of a three dimensional modeling/rendering software platform.

5. A process in claim 1 wherein users of a three dimensional modeling/rendering software platform will create and/or manipulate a three dimensional model/rendering of a home, business, vehicle, structure, and/or building and implement various uploaded products and services into said model/rendering.

6. A process in claim 5 wherein users of a three dimensional modeling/rendering software platform will be able to pick and choose from thousands of different products and services and implement them into a 3D model/rendering after uploading of said products and services has taken place.

7. A process in claim 6 wherein users will be able to see how three dimensional models/renderings of products and services will look in three dimensional space within a three dimensional model/rendering of a home, business, structure, vehicle, and/or building.

8. A process in claim 1 wherein a user will send a created and/or manipulated three dimensional model/rendering with uploaded products and services implemented to a virtual marketplace.

9. A process in claim 8 wherein a user will send a created and/or manipulated three dimensional model/rendering with uploaded products and services implemented to a virtual marketplace via a direct, secure, and electronic linkage.

10. A process in claim 1 wherein commercial entities that are part of the virtual marketplace will compete to facilitate the construction, remodeling, manufacturing, designing, buying, and/or selling of homes, businesses, vehicles, structures, and/or buildings that are sent to the virtual marketplace as a three dimensional model/rendering.

11. A process in claim 10 wherein commercial entities that are part of the virtual marketplace will be able to give estimates, make bids, advertise and offer their products and services for, create contracts, accept credit and/or monetary transactions, target geographical areas and consumer demographics, and/or seek out business opportunities pertaining to three dimensional models/renderings of homes, businesses, vehicles, structures, and/or buildings.

12. A process in claim 1 wherein users can create a three dimensional model/rendering of a home, business, vehicle, structure, and/or building from scratch using applications within a software platform.

13. A process in claim 1 wherein users can upload architectural plans and engineering schematics into a three dimensional modeling/rendering software platform where applications in said platform will convert the plans and schematics into a three dimensional model/rendering wherein uploaded products and services can be implemented.

14. A process in claim 1 wherein a virtual marketplace will be created as a web-based interface where users of three dimensional modeling/rendering software platforms will be able to send created and/or manipulated three dimensional models/renderings of homes, businesses, structures, vehicles, and/or buildings via a direct, secure, and electronic linkage so that commercial entities will compete for the facilitation of any construction, remodeling, manufacturing, designing, buying, and/or selling projects associated with said three dimensional model/rendering.

15. A process in claim 1 wherein all existing and yet to be discovered products and services utilized in the construction, remodeling, manufacturing, designing, buying, and/or selling of homes can be uploaded by commercial entities into a three dimensional modeling/rendering software platform and implemented into a three dimensional model/rendering of a home that is created and/or manipulated by a user of said software platform.

16. A process in claim 1 wherein all existing and yet to be discovered products and services utilized in the construction, remodeling, manufacturing, designing, buying, and/or selling of a business can be uploaded by commercial entities into a three dimensional modeling/rendering software platform and implemented into a three dimensional model/rendering of a business that is created and/or manipulated by a user of said software platform.

17. A process in claim 1 wherein all existing and yet to be discovered products and services utilized in the construction, remodeling, manufacturing, designing, buying, and/or selling of a structure can be uploaded by commercial entities into a three dimensional modeling/rendering software platform and implemented into a three dimensional model/rendering of a structure that is created and/or manipulated by a user of said software platform.

18. A process in claim 1 wherein all existing and yet to be discovered products and services utilized in the construction, remodeling, manufacturing, designing, buying, and/or selling of a vehicle can be uploaded by commercial entities into a three dimensional modeling/rendering software platform and implemented into a three dimensional model/rendering of a vehicle that is created and/or manipulated by a user of said software platform.

19. A process in claim 1 wherein all existing and yet to be discovered products and services utilized in the construction, remodeling, manufacturing, designing, buying, and/or selling of a building can be uploaded by commercial entities into a three dimensional modeling/rendering software platform and implemented into a three dimensional model/rendering of a building that is created and/or manipulated by a user of said software platform.
